(19) United States
(12) Patent Application Publication
(10) Pub. No.: US 2016/0158627 A1
(43) Pub. Date: Jun. 9, 2016

(54) PERFORMANCE ENHANCING BITE REGULATOR AND SELF-IMPRESSION SYSTEM AND METHOD OF CUSTOM FITTING SAME

(71) Applicant: PX3 SPORTS SCIENCE, Calgary (CA)

(72) Inventor: P. Bradley Layzell, Calgary (CA)

(21) Appl. No.: 14/906,169

(22) PCT Filed: Jul. 21, 2014
(86) PCT No.: PCT/IB2014/001365

§ 371 Date: Jan. 19, 2016

Related U.S. Application Data
(60) Provisional application No. 61/856,399, filed on Jul. 19, 2013.

(51) Int. Cl. A63B 71/08; A61C 19/05

(52) U.S. Cl. CPC A63B 71/085; A61C 19/05

(57) ABSTRACT

A method of custom fitting a mouth piece includes providing a self-impression kit with at least one dental impression bite registration tool, impression material, and instructions. The instructions direct the steps of: a) determining a natural or symmetrical bite position of a subject utilizing the bite registration tool; b) applying impression material to an intraoral portion of the bite registration tool; c) placing the bite registration tool and the impression material in the subject's mouth; d) forming an impression of the subject's teeth and gums in the impression material by the subject biting on the intraoral portion of the bite registration tool in the previously determined natural bite position; and e) delivering the bite registration tool and formed impression material to a manufacturer to have a bite regulator fabricated using the formed impression.

### RELATED APPLICATION DATA

This patent is related to and claims priority benefit of U.S. provisional application Ser. No. 61/856,399 filed on Jul. 19, 2014 and of the same title. The entire content of this prior filed provisional application is hereby incorporated herein by reference.

### BACKGROUND

1. Field of the Disclosure

The present invention relates generally to oral appliances, and more particularly to method of fitting a bite regulator that regulates a wearer's jaw and bite position during use to increase oxygen, neurological, and physiological response and maintain proper neuromusculoskeletal alignment under high impact and high stress environments.

2. Description of Related Art

There are many appliances and products that are to be worn in the mouth. Such appliances also can serve many different purposes. Some of these products are intended to be worn while participating in athletic endeavors. Many appliances of this type are worn by athletes as mouth guards and are intended to protect the athlete's teeth.

U.S. Pat. No. 7,404,403 discloses an oral appliance in the form of a mouth guard or sports guard. The sports guard 1 is to be placed in a mouth of a user. The guard 1 has a base member 2 with a generally U-shaped form corresponding to the outline of a jaw of a user and defines an upper channel 10 within which the upper row of teeth of a user are received. The guard also has a teeth-engaging element 3 associated with the channel 10 and made of a material that can be shaped or formed by a user to be molded to their mouth. The guard also has a shock absorption aspect associated with the base member 2 for absorbing impact shock. The shock absorption aspect utilizes open channels in the base member 2 that are to simulate air springs. The base member also has a polyethylene mixed with up to 10% of EVA. The addition of EVA is said to give the guard more flexibility. The teeth engaging element is made of EVA.

U.S. Pat. No. 6,082,363 (E-Z Gard Industries, Inc.) discloses a triple layer mouth guard with an integral shock absorbing framework. The triple layer mouth guard apparatus has a U-shaped mouth guard base with an elastomeric frame embedded therein. The frame includes a wave-shaped contact surface. The mouth guard base has inner and outer side walls that define an upper channel, which has a liner disposed therein. The liner is adapted to form around the teeth of the wearer when softened. The liner engages the teeth of the upper jaw and is made of a material that softens at a temperature lower than the material of the mouth guard base and remains softer than the material of the mouth guard base when hardened.

U.S. Pat. No. 7,210,483 (Medtech Products, Inc.) discloses an interocclusal sports prophylaxis that includes a core having an arch-shaped occlusal plate with upwardly extending buccal and lingual walls. A labial force dispersal shield and molar framing braces extend downwardly from the plate at incisor and lingual zones of the plate. The occlusal plate is thickened at the molar and incisor zones so that breathing spaces are provided between mandibular occlusal surfaces not registered with the zones and a mandibular face of the plate. A shock absorption dentition encasement is molded over the upper surface of the core and also covers the molar and incisor zones. The prophylaxis is heated in water and then seated in the mouth. Biting pressure is applied to embed the maxillary dentition in the encasement and the lower incisor and molar occlusal surfaces in the encasement covering the zones.

U.S. Pat. No 7,305,990 (Den-Mat Corporation) discloses a mouth guard and kit with a user-configured mouth guard. The user's teeth and gums are not directly exposed to the uncured mouth guard material. The uncured mouth guard material is pliant at room temperature and does not have to be heated to form and shape the mouth guard. The cured mouth guard can be pliant or rigid at room temperature. A kit and a method of forming the mouth guard are also disclosed.

U.S. Pat. No. 6,830,051 (Dental Concepts LLC) discloses an interocclusal appliance that includes a maxillary impression preform of a resilient thermoplastic having a low softening temperature, e.g. 36 degree C., such as an EVA copolymer having approximately thirty percent vinyl acetate. The preform is molded over and unitarily bonded to a base having a planar bottom face contacted by mandibular occlusal surfaces. The base is formed of a thermoplastic having a higher softening temperature, e.g. 70 degree C., with the bond between the preform and base characterized by high shear strength. The preform includes a bight shaped centric relation positioning channel having a thick footing and draft along lingual, buccal, and labial walls. The appliance is fitted by immersion in hot water to soften the preform, seating the maxillary arch within the channel and biting, such that the impression of the maxillary dentition embeds in the softened preform. Upon cooling, the preform is transformed into a reusable resilient encasement for the maxillary dentition. Suitable thermoplastics for implementation as the base include an EMA copolymer, blends of EMA and EVA or TPU, or blends of TPU and EVA.

The foregoing products may offer some type of improvement over standard, inexpensive athletic mouth guards. However, all have significant disadvantages as well. Such disadvantages are discussed below throughout the detailed description but generally include not accounting for a user's natural jaw position, restricting the user's airway, restricting verbal communication during use, and the like.

### SUMMARY

In one example according to the teachings of the present disclosure, a method of custom fitting a mouth piece includes providing a self-impression kit with at least one bite registration tool, impression material, and instructions. The instructions direct the steps of: a) determining a natural bite position of a subject utilizing the bite registration tool; b) applying impression material to an intraoral portion of the bite registration tool; c) placing the bite registration tool and the impression material in the subject's mouth; d) forming an impression of the subject's teeth and gums in the impression material by the subject biting on the intraoral portion of the bite registration tool in the previously determined natural bite position; and e) delivering the bite registration tool and formed impression material to a manufacturer to have a bite regulator fabricated using the formed impression.

In one example, the step of providing can includes providing a plurality of the bite registration tools.

In one example, at least two tools of a plurality of the bite registration tools in the kit can be configured differently from one another. Each of the at least two tools can be configured to accommodate a different natural bite position type.

In one example, the step of providing can include providing multiple packages of the impression material.

In one example, the step of determining can include instructing that the natural fore-aft position of the subject's upper front teeth be determined relative to the subject's lower front teeth in the natural bite position.

In one example, the step of determining can include instructing that the natural vertical spacing of the subject's upper front teeth be determined relative to the subject's lower front teeth in the natural bite position.

In one example, the step of determining can include instructing that the natural side-to-side position of the subject's upper front teeth be determined relative to the subject's lower front teeth in the natural bite position.

In one example, the step of determining can include instructing that: a) the natural fore-aft position of the subject's upper front teeth be determined relative to the subject's lower front teeth in the natural bite position; b) the natural vertical spacing of the subject's upper front teeth be determined relative to the subject's lower front teeth in the natural bite position; and c) the natural side-to-side position of the subject's upper front teeth be determined relative to the subject's lower front teeth in the natural bite position. In one example each of these determinations can be made using the bite registration tool.

In one example, the step of providing can include providing one or more dental impression bite registration bite forks as the bite registration tools. The dental impression bite registration bite forks can define upper and lower notches for receiving the respective upper and lower front teeth of the subject during the steps of determining and forming.

In one example, wherein the instructions for the steps of applying, placing, and forming can direct that they be performed for the teeth and gums on a first side of the subject's mouth and then be repeated for the teeth and gums on the second side of the subject's mouth. The formed impression material from the first side can remain on the bite registration tool when the steps of applying, placing, and forming are performed for the second side.

In one example, the steps of determining, applying, placing, and forming can further include instructing that these steps be performed by the subject, by a user assisting the subject, or both.

In one example according to the teachings of the present invention, a method of custom fabricating a mouth piece includes providing a self-impression kit having at least one bite registration tool, impression material, and instructions. The instructions direct a subject to: a) determine their natural bite position utilizing the bite registration tool, b) apply impression material to an intraoral portion of the bite registration tool, c) place the bite registration tool and the impression material in their mouth, d) form an impression of their teeth and gums in the impression material by biting on the intraoral portion of the bite registration tool in the previously determined natural bite position, and e) deliver the bite registration tool and formed impression material to a manufacturer to have a bite regulator fabricated using the formed impression.

In one example, the step of providing can include providing at least two of the bite registration tools. Each bite registration tool can be configured differently from one another and can be configured to accommodate a different natural bite position type.

In one example, the step of determining can include instructing the subject to determine the natural fore-aft position of their upper front teeth relative to their lower front teeth in the natural bite position.

In one example, the step of determining can include instructing the subject to determine the natural vertical spacing of their upper front teeth relative to their lower front teeth in the natural bite position.

In one example, the step of determining can include instructing the subject to determine the natural side-to-side position of their upper front teeth relative to their lower front teeth in the natural bite position.

In one example, the step of determining can include instructing the subject to determine: a) the natural fore-aft position of their upper front teeth relative to their lower front teeth in the natural bite position; b) the natural vertical spacing of their upper front teeth relative to their lower front teeth in the natural bite position; and c) the natural side-to-side position of their upper front teeth relative to their lower front teeth in the natural bite position.

In one example, the instructions for the steps of applying, placing, and forming can direct the subject to perform these steps for their teeth and gums on a first side of their mouth, and then subsequently repeat these steps for their teeth and gums on the second side of their mouth while leaving the formed impression material from the first side on the bite registration tool when the steps of applying, placing, and forming are performed for the second side.

In one example, the step of delivering for any disclosed method herein can result in the manufacturer producing a bite regulator that has a front band with left and right ends, and left and right molar sections extending rearward respectively from the left and right ends of the front band. The left and right molar sections can each have an interocclusal region with a contoured top surface and a contoured bottom surface. The contoured top and bottom surfaces can be each configured to match a specific contour of the wearer's top and bottom teeth, respectively, and can be aligned relative to one another to correctly position the wearer's jaw.

In one example, the step of delivering can result in the manufacturer producing a bite regulator wherein a front band is a labial band configured to contact only an outer facing side of the subject's front teeth.

### BRIEF DESCRIPTION OF THE DRAWINGS

Objects, features, and advantages of the present invention will become apparent upon reading the following description in conjunction with the drawing figures, in which:

FIG. 1 shows a perspective view of one example of a lower bite regulator constructed in accordance with the teachings of the present disclosure.

FIG. 2 shows a front view of the lower bite regulator of FIG. 1.

FIG. 3 shows a top view of the lower bite regulator of FIG. 1.

FIG. 4 shows a bottom view of the lower bite regulator of FIG. 1.

FIG. 5 shows a side view of the lower bite regulator of FIG. 1.

FIG. 6 shows a rear view of the lower bite regulator of FIG. 1.

FIG. 7 shows a rear view of the lower bite regulator of FIG. 1, but with an optional tongue shelf on the lingual walls.

FIG. 8A shows a comparison between a prior art oral appliance and the lower bite regulator of FIG. 1 and on a lower set of teeth.

FIG. 8B shows a front view of a prior art oral appliance on a lower set of teeth.

FIG. 8C shows a front view of the lower bite regulator of FIGS. 1 and 8A on a lower set of teeth.

FIGS. 9A and 9B show cross section views of the lower bite regulator taken along lines 9A-9A and 9B-9B of FIG. 8A.

FIG. 10 shows a cross-section of the lower bite regulator between upper and lower molars of a wearer.

FIG. 11 shows a perspective view of one example of a hybrid lower bite regulator constructed in accordance with the teachings of the present disclosure.

FIG. 12 shows a front view of the lower bite regulator of FIG. 11.

FIG. 13 shows a top view of the lower bite regulator of FIG. 11.

FIG. 14 shows a bottom view of the lower bite regulator of FIG. 11.

FIG. 15 shows a side view of the lower bite regulator of FIG. 11.

FIG. 16 shows a rear view of the lower bite regulator of FIG. 11.

FIG. 17 shows a cross section of the front band of the lower bite regulator of FIG. 1 and on a set of lower teeth.

FIG. 18 shows a perspective view of one example of a hybrid lower bite regulator constructed in accordance with the teachings of the present disclosure.

FIG. 19 shows a front view of the lower bite regulator of FIG. 18.

FIG. 20 shows a top view of the lower bite regulator of FIG. 18.

FIG. 21 shows a bottom view of the lower bite regulator of FIG. 18.

FIG. 22 shows a side view of the lower bite regulator of FIG. 18.

FIG. 23 shows a rear view of the lower bite regulator of FIG. 18.

FIG. 24 shows a cross section of the front band of the upper bite regulator of FIG. 18 and on a set of teeth.

FIG. 25 shows a perspective view of the upper bite regulator of FIG. 18 spaced from a set of upper teeth and showing differences between a prior art mouth piece and the upper bite regulator.

FIG. 26 shows a schematic representation of pull forces exerted by a person's head on the neck muscles.

FIG. 27A shows a representation of how the disclosed fitting system and resulting custom mouth piece can increases the airway opening of a user wearing the mouth piece.

FIGS. 27B shows a representation of how the disclosed fitting system and resulting custom mouth piece can stabilize the jaw of a user wearing the mouth piece.

FIG. 28 shows one example of a self-impression kit for custom fitting a bite regulator according to the teachings of the present disclosure.

FIG. 29 shows one example of a dental impression bite registration tool that can be provided with the self-impression kit of FIG. 28.

FIG. 30 shows another example of a dental impression bite registration bite fork that can be provided with the self-impression kit of FIG. 28.

FIGS. 31A and 31B show another example of a dental impression bite registration bite fork that can be provided with the dental impression bite registration bite fork of FIG. 30 and with the self-impression kit of FIG. 27 and two different usable orientations.

FIGS. 32A-32C show which of the dental impression bite registration bite forks in FIGS. 30 and 31A and/or which orientation of the dental impression bite registration bite fork in FIGS. 31A and 31B to use for a particular bite class of a user.

FIG. 33 shows a user placing a quantity of mixed and ready impression material on one side of a selected dental impression bite registration bite fork.

FIG. 34 shows a front view of the dental impression bite registration bite fork of FIG. 33 positioned within a user's mouth and with their teeth and the dental impression bite registration bite fork centered relative to one another.

FIG. 35 shows the dental impression bite registration bite fork after an impression of one side of the user's teeth has been taken.

FIG. 36 shows the dental impression bite registration bite fork of FIG. 35 and with additional impression material added to the other side of the dental impression bite registration bite fork.

FIG. 37 shows a view of a user after having placed the dental impression bite registration bite fork and additional impression material of FIG. 36 into their mouth.

FIGS. 38A and 38B show top and bottom views, respectively, of the dental impression bite registration bite fork and impression material of FIG. 37 after the full impression has been made of the user's teeth and gums.

### DETAILED DESCRIPTION OF THE DISCLOSURE

The disclosed invention is for a new oral appliance called the PX3 Bite Regulator and for a method that allows individuals to self-fit such an appliance. The product design and fitting method solve or improve upon one or more problems and disadvantages with existing and prior known oral appliances, mouth guards, fitting methods, and the like.

Scientific research conducted using the disclosed oral appliances shows proven ground breaking improvements in product performance, and more important, in the performance of the athlete or user of the product. The research and test results have shown that the products can significantly reduce the occurrence of concussions in contact sports, sometimes by as much as 80% or more. Institutional research and test results have also proven a statistical increase (p>0.05) in both aerobic and anaerobic capacities. The disclosed oral appliances may be a suitable or superior replacement for virtually every mouth guard on the market. The disclosed oral appliances is proven to improve performance of individuals as they undertake any number of activities, not just contact sports, whether for youth, high school, recreational, collegiate, professional, or Olympic competition. The disclosed oral appliances have also been proven to improve the performance of military personnel, firemen, members of law enforcement, first responders and the like. The disclosed oral appliances have also been proven to improve the quality of sleep for healthy people and those suffering from sleep disorders.

The disclosed oral appliance can be categorized and described as fully customized bite-positioning mouthpieces that maintain optimized jaw alignment and allow for enhanced and unobstructed breathing. The disclosed mouthpieces also allow for unobstructed communication, and drinking while the products are being used. The disclosed mouthpieces also allow for more efficient (higher flow with less energy demands) circulation of blood and oxygen throughout the body's internal operating systems. The disclosed PX3 Custom Bite Regulators are scientifically proven to increase oxygen volumes, heart rate variability, cognitive processing and dopamine (neurotransmitters directly linked with movement, attention, and learning), and reduces stress, anxiety and promotes a more efficient operation of the autonomic nervous system in individuals using the product in comparison to using prior or no mouthpieces.

During high impact and high stress environments, the human body's natural response is to go into a defensive state, clench the jaw and stop breathing. Lack of oxygen triggers the sympathetic nervous system to take preventative safety measures, pulling blood back from the extremities to protect vital organs, effectively shutting down parts of the brain that control fine motor skills, vision, hearing, depth perception that make simple tasks more difficult, resulting in poor performance, higher risk of mistakes and of injury. While using the disclosed PX3 Bite Regulators, testing has shown that an athlete is able to transfer higher oxygen levels by properly aligning and stabilizing the jaw position, thereby eliminating the ability to clench the teeth together and completely shut off the flow of oxygen. This feature allows the person to maintain a consistent flow of oxygen to the brain, remain calm and focused and to execute when normally they would not be able to. The effects of this increase in oxygen on training and cognitive function compounding day after day, week after week, and month after month, are measurably significant. For these types of high stress, high impact, and/or high intensity environments, it is simply not possible for one to perform at the same level with no mouthpiece, and even more difficult with a traditional mouth guard where breathing and communication is restricted through excess material or jaw misalignment.

Traditional mouth guards are not designed to increased breathing, properly align or stabilize the jaw, they are designed to for protecting teeth, lips and gums. Some protective headgear products, such as football helmets, are strapped tight to a wearer's head by a taught chinstrap. This can further misalign the player's jaw, making it even harder to breath, and communicate. This further increases stress on the autonomic nervous system, reduces their ability to function, both mentally and physically and puts the athlete at a much higher risk of getting hurt or in the case of military combat, getting killed or doing long-term permanent damage. The same can be said for many individuals that regularly must perform under stressful conditions.

The disclosed oral appliances, i.e., the Custom Bite Regulators promote and enhance human performance levels. The products are natural, clean, use only FDA approved materials, and can be used for all levels and types of competition and physical activity. The disclosed Bite Regulators are not a corrective orthotic for severe jaw disorders or pain management. The Bite Regulators are specifically designed for symmetrical alignment and stability to increase respiratory, physiological and neurological performance. The disclosed Bite Regulators are not a mouth guard or gum shield. Custom mouth guards involve one (1) single impression of the wearer's teeth and are designed for full dental coverage and minor tooth, lip and gum protection. The disclosed Bite Regulators involve nine (9) unique custom measurements and use a single dental impression bite registration tool or digital intraoral scan to capture: 1) full anatomy of the maxillary teeth; 2) full anatomy of the mandibular teeth; 3) full labial registration of the upper or lower gums, depending on the mouth piece model; 4) precise left side vertical positioning of maxillary and mandibular lateral incisors, canine, premolar, and molars; 5) precise right side vertical positioning of maxillary and mandibular lateral incisors, canine, premolar, and molars; 6) precise left side horizontal positioning of maxillary and mandibular lateral incisors, canine, premolar, and molars; 7) precise right side horizontal positioning of maxillary and mandibular lateral incisors, canine, premolar, and molars; 8) precise vertical positioning of maxillary and mandibular centric incisors; and 9) precise horizontal positioning of maxillary and mandibular centric incisors.

Athletic mouthguards and most custom orthotics restrict airway, communication, misalign the bite or do not stabilize the jaw, which increases stress and energy demands on the autonomic nervous system, tiring the person faster, and in doing so, indirectly increasing the risk of injury during even minimal levels of physical activity. The disclosed Bite Regulators are custom fitted using dental impressions of top and bottom arches, jaw position, and proper vertical, sagittal and horizontal bite position. Existing mouth wear does not encompass all of these parameters. The disclosed Bite Regulators are designed to provide enhanced postural alignment, to stabilize the jaw, to allow for unobstructed breathing, speaking, increasing physiological performance, and indirectly reduce the overall risk of all injuries, including concussions. They are also used in sleep, rehabilitation and alternative preventative treatment options. The gains in oxygen, performance and reduction in injury risk are not a direct result of the disclosed appliances directly absorbing impact energy or chemically altering one's physiology. Instead, these improvements are mainly achieved as a result of the athlete or individual being able to consistently increase the flow and quantity of oxygen to the brain and body, gain more efficiency of the skeletal, neurological and autonomic systems, and empower people to maintain peak power, endurance, and cognitive function longer. It is well understood and scientifically proven that higher fatigue levels directly increase our risk of failure, injury, disease and death. These and other objects, features, and advantages of the present invention will become apparent to those having ordinary skill in the art upon reading this disclosure.

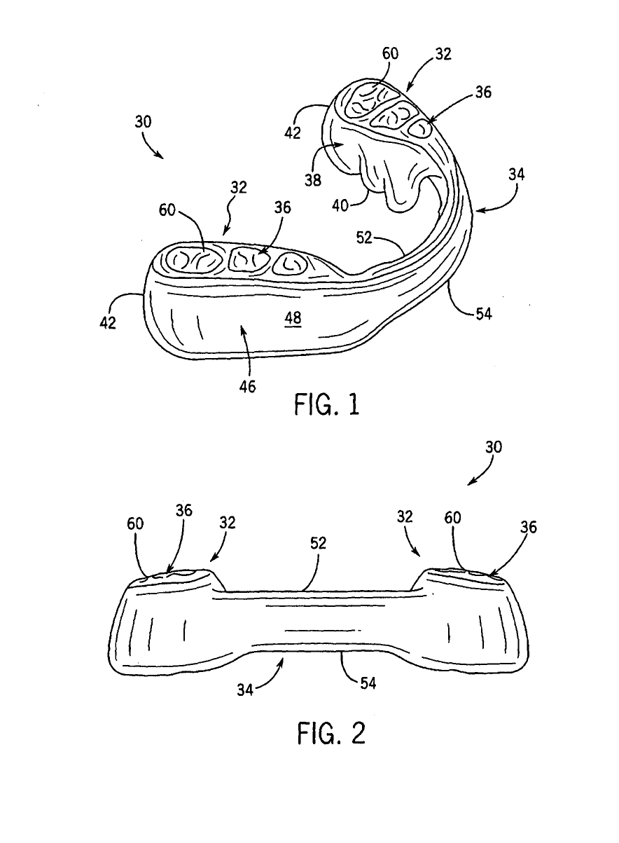

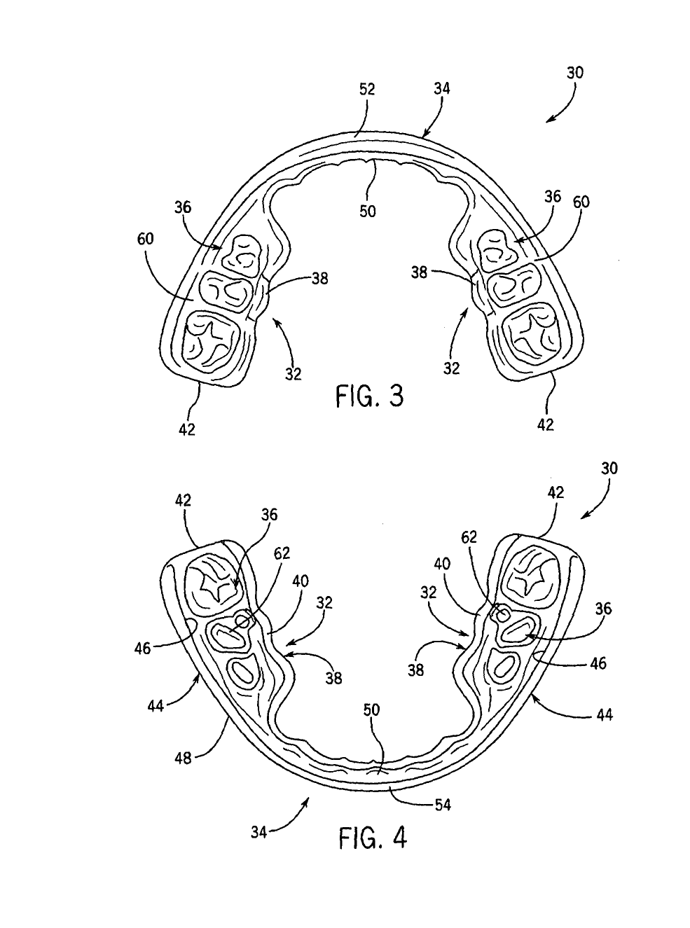

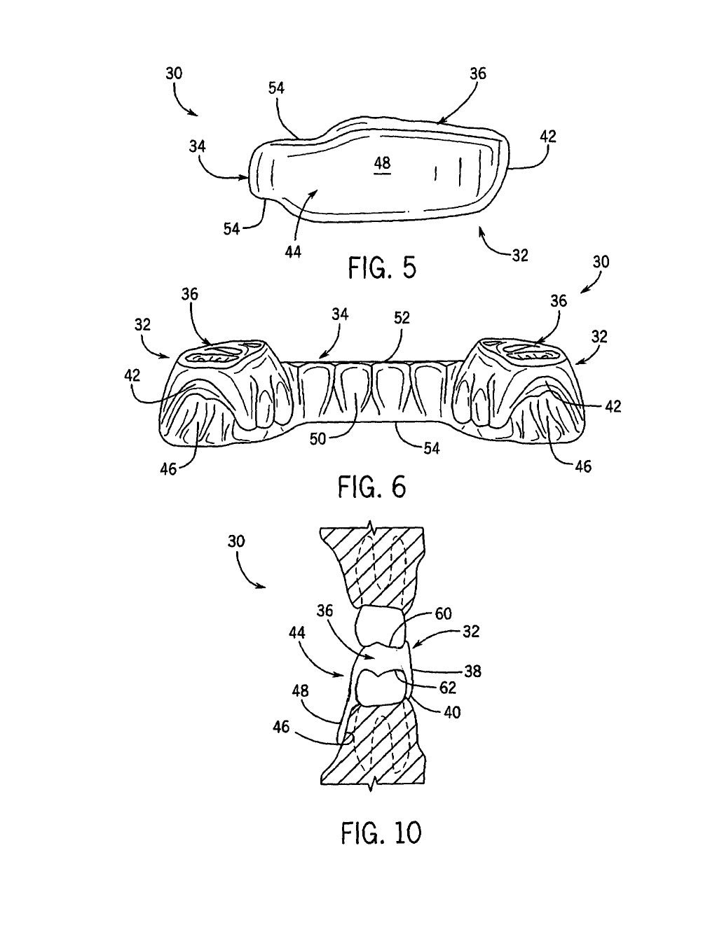

Turning now to the drawings, one example of the bite regulator or oral appliance constructed in accordance with the teachings of the present disclosure is illustrated in FIGS. 1-6. The oral appliance in this example is intended to fit over only portions of the bottom teeth of a wearer and is thus identified herein as a lower bite regulator 30. The lower bite regulator 30 has a pair of rear left and right molar sections 32 and a front band 34, or in this example a labial band interconnected to the rear molar sections at left and right ends of the labial band. The lower bite regulator 30 is unique in comparison to prior known oral appliances, mouth guards, and the like in a number of ways.

Each of the molar sections 32 has a top, relatively thick interocclusal region or portion 36 that is configured to rest between the molars of the wearer. Each molar section 32 also has a lingual wall 38 on an inner side or edge of the respective molar section. Each lingual wall 38 in this example depends downward from the respective molar section 32 and is contoured in two ways. First, the lingual wall 38 has a relatively thin wall thickness and is contoured (both inside/tooth facing side and outside/tongue facing side surfaces) to match the lateral, inner, or lingual surface contour of the adjacent molars. Second, the lingual wall 38 has a lower edge 40 that is contoured vertically so that the wall terminates at and follows the inner facing side or surface contour of the molars and does not contact any soft tissue or otherwise overlap any of the gums of the wearer. Each molar section 32 also has a short depending rear lip 42 that hangs over, in this example, a rear edge of the third (not the fourth or rearmost) molar between the third and fourth molars on each side of the wearer's mouth.

Each molar section 32 also has a buccal wall 44 on an outer side or edge of the respective molar section. In this example, the buccal walls that faces outward toward the wearer's cheek. In one example, an inner surface 46 of the buccal wall 44 can be contoured to conform to and closely follow the curvature and contour of the outer facing side of the wearer's molars. A buccal facing side or outer surface 48 of the buccal wall 44 can be relatively smooth. In another example, the outer surface or buccal facing side 48 of the buccal wall 44 could instead be contoured to generally match the contour of the inner surface 46. In such an example, the comfort for the wearer may be increased and the overall buccal wall thickness reduced to save material usage. In either example, the buccal walls 44 depend from the respective molar section 32 because the bite regulator 30 is worn on the lower teeth of a wearer. Each buccal wall 44 can have a height sufficient to cover a substantial portion of the wearer's soft tissue or gums on the buccal side of their lower teeth. In another example, in order to save material, each buccal wall can instead be contoured vertically so that the wall terminates at and follows the contour of the outer facing surfaces of the molars and does not contact any soft tissue or otherwise overlap any of the gums of the wearer.

The front band in this example is referred to as a labial band in that it is positioned on only the forward facing or labial side of the wearer's front lower teeth and interconnects the two molar sections 32. A rear side or surface 50 of the labial band 34 in this example is also contoured to custom fit or closely follow the contour of the forward facing labial surfaces of the wearer's front teeth. The height of the labial band 34 is such that a top edge 52 terminates at about the top edge of the wearer's lower front teeth but does not extend over the top edge. A lower edge 54 of the labial band terminates at, or just above the wearer's gum line. Again, the lower edge 54 of the labial band 34 can be contoured so that no portion of the labial band extends downward to contact the soft tissue or otherwise overlap any portion of the soft tissue or gums of the wearer's mouth. In fact, the lower edge 54 of the labial band 34 can terminate above the gum line, if desired.

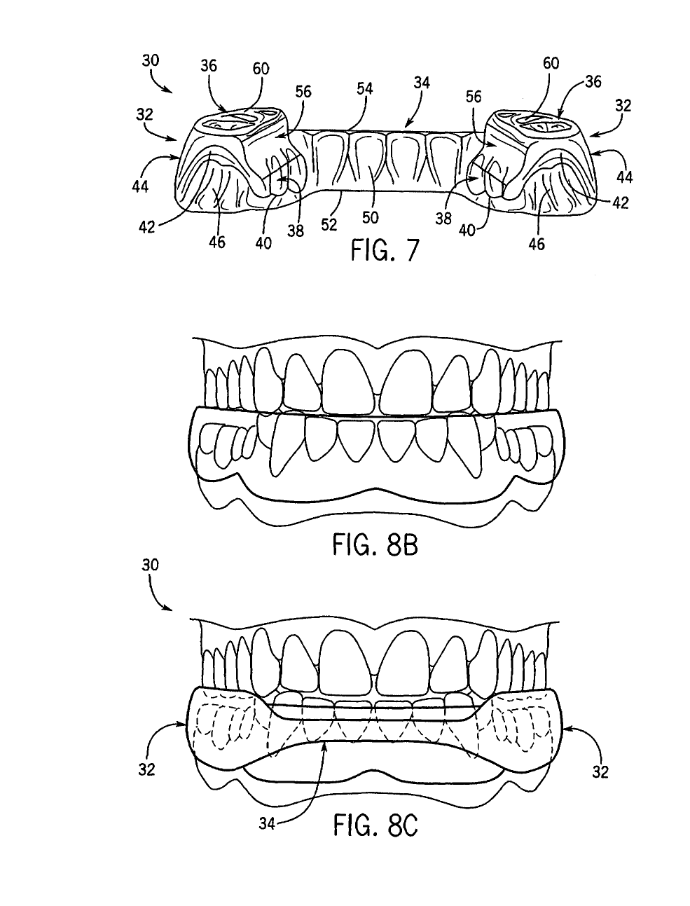

The lingual wall 38 of the molar sections 32 can include a comparatively thin wall thickness in comparison to prior known mouth guards. This can save on material usage, reduce obstruction in the wearer's airway, reduce distraction to the user wearing the device, and increase overall comfort for the wearer. Since there is less material covering the inner surface of the teeth, there is less obstruction between their tongue and the lower bite regulator during use, opening the airway and increasing comfort. The lingual wall 38 on the molar sections 32 is relatively thin because it is on the inside of the wearer's teeth and not on the outside. The lingual wall 38 of the molar sections 32 also can include an optional tongue shelf 56 in the form of a recess, depression, or scallop along the lingual wall, as shown in FIG. 7. The tongue shelf 56 can be provided to assist in properly locating the tongue for the wearer during use. The tongue shelf 56 will naturally allow the tongue to move forward, further opening the airway and providing a comfortable position resting on the lower bite regulator 30 while the device is being worn. Proper and relaxed tongue positioning will further increase oxygen intake and reduce required energy or stress on the wearer.

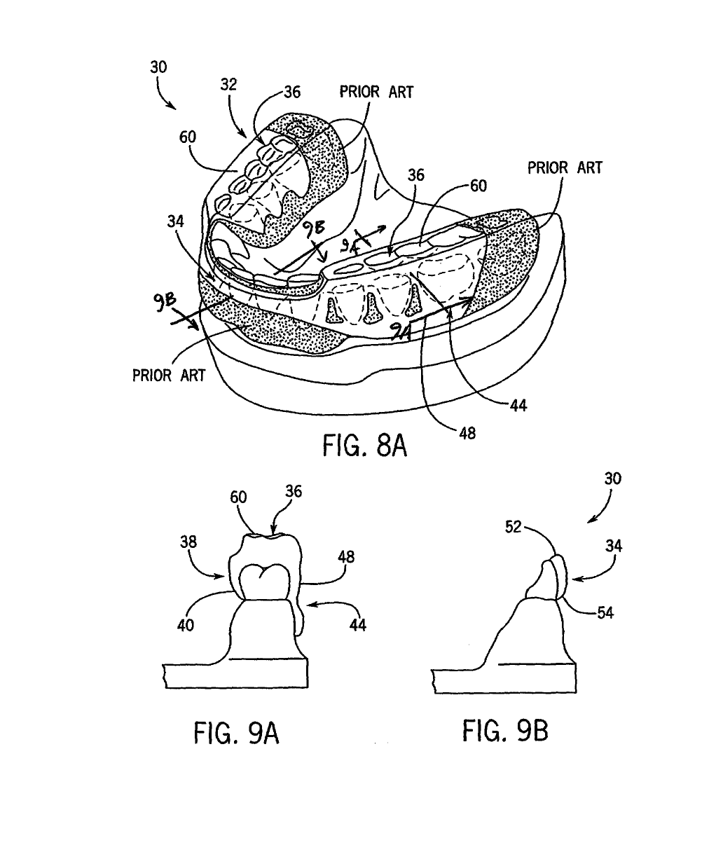

The rearward depth of the molar sections 32 on the lower bite regulator 30 is such that it does not cover all four of the molars on either side of the wearer's mouth. Instead, the molar sections 32 are truncated in comparison to all prior known mouth guards, mouth pieces, oral appliances, and the like. Those prior known devices typically cover all of the wearer's molars and thus extend further rearward into the mouth and require more material to manufacture. See FIGS. 8A-8C, which show comparisons between the disclosed lower bite regulator 30 and an existing oral appliance device. FIG. 8A shows a perspective view of the lower bite regulator 30 on a set of lower teeth with the larger dimensions of existing devices depicted in the darker regions in the drawing. FIG. 8B shows a front view of a prior known oral appliance or lower mouth guard on a set of lower teeth of a wearer. FIG. 8C shows a front view of the lower bite regulator 30 on a set of lower teeth of a wearer. With the material on prior know devices extending further rearward into the wearer's mouth and further downward onto the soft tissue of the wearer's mouth, comfort is decreased, tongue interference is increased, and airway obstruction is increased. In contrast, the lower bite regulator 30 as disclosed herein uses significantly less material, eliminates this uncomfortable rear obstruction in the wearer's mouth, is much less intrusive so as to be less of a distraction to the wearer, and opens the airway for the user while wearing the device.

The top surfaces 60 of the interocclusal portions 36 of the molar sections 32 are custom molded to fit and engage the bottom facing side of the upper molars of a specific wearer or subject. The underside surfaces 62 of the interocclusal portions 36 of the molar sections 32 are custom molded to fit and engage the top side of the bottom molars of the specific wearer of subject. As described below, the positioning of these corresponding, mating depressions in the interocclusal portions 36 of the molar sections 32 is precisely fitted such that the wearer's upper and lower jaws, i.e., their bite alignment is registered and positioned for their correct or voluntary bite position, i.e., their natural and symmetrical neuromusculoskeletal alignment during use. When the wearer installs the lower bite regulator 30 and bites down on the device, their upper and lower jaws and teeth will register with one another at their correct natural or voluntary bite position and thus be in the most natural and comfortable alignment. This can significantly reduce stress in the wearer's jaw, resulting in reduced stress on the underlying parasympathetic and sympathetic systems and physiology of the wearer. During use, the wearer will naturally maintain a closed or clenched jaw position.

The disclosed lower bite regulator 30 is unique in that it still provides significant interocclusal impact protection in the same manner as a mouth guard while significantly reducing the size, material usage, and negative impact of wearing such an appliance in one's mouth during strenuous and stressful activity. See FIGS. 9A and 9B, which show a cross-section of the molar section and the labial band. The disclosed lower bite regulator 30 provides unobstructed breathing while the device is worn, allowing the wearer to consistently fuel the body, brain, and blood stream even under stressful and strenuous activity and stimulus. The disclosed lower bite regulator 30 helps to maintain a natural bite position and jaw registry for the user as well. The optional tongue shelf 56 of the lower bite regulator 30 minimizes the subconscious reaction to a foreign obstruction being placed in the mouth and helps to naturally locate or place the wearer's tongue in a relaxed, natural position within the mouth during use. The contouring on the disclosed lower bite regulator 30, and particularly the contouring on the lingual walls 38 of the molar sections 32, and the complete lack of a lingual wall on the labial band 34 in this example, significantly improves the wearer's ability to breathe and to communicate while wearing the device. See FIGS. 9A and 9B. The disclosed lower bite regulator 30 only employs thicker material regions where necessary, and particularly on the interocclusal portion 36 of the molar sections 32 between the wearer's upper and lower teeth, as depicted in FIG. 10.

The disclosed lower bite regulator 30 can be fabricated from any suitable material such as polymers or hard or soft thermoplastics. The disclosed products can also be made from more than one material, such as in a dual molding process. Likewise, the disclosed lower bite regulator 30 can be made and formed with different colored portions, clear portions, logos, and the like to enhance the aesthetic appearance and overall performance of the product. Material inserts can be fabricated during the molding process and placed, for example, in the interocclusal portions to provide further impact performance or absorption characteristics, if desired. The disclosed lower bite regulator 30 and other by regulators described herein are not intended to be limited to use of any particular material.

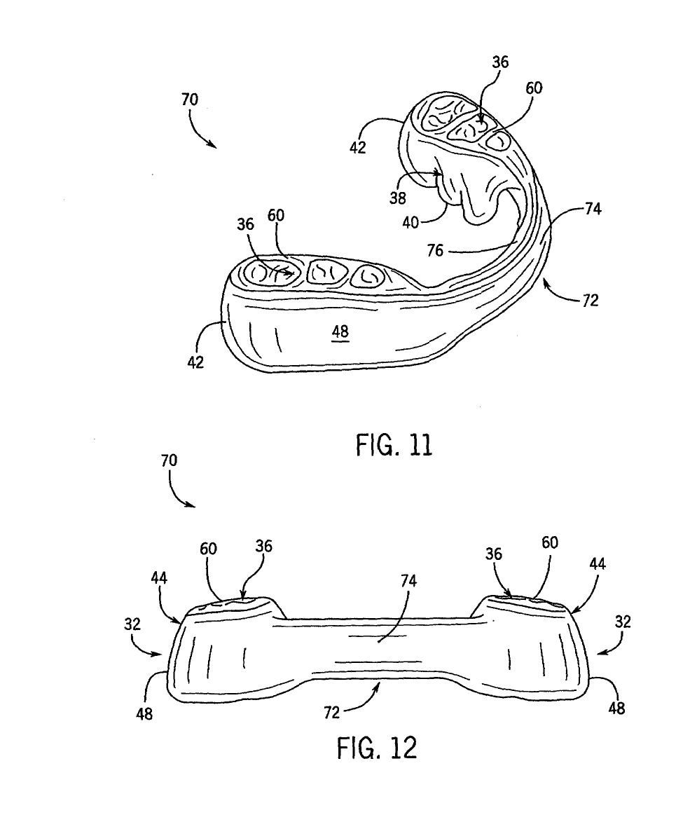

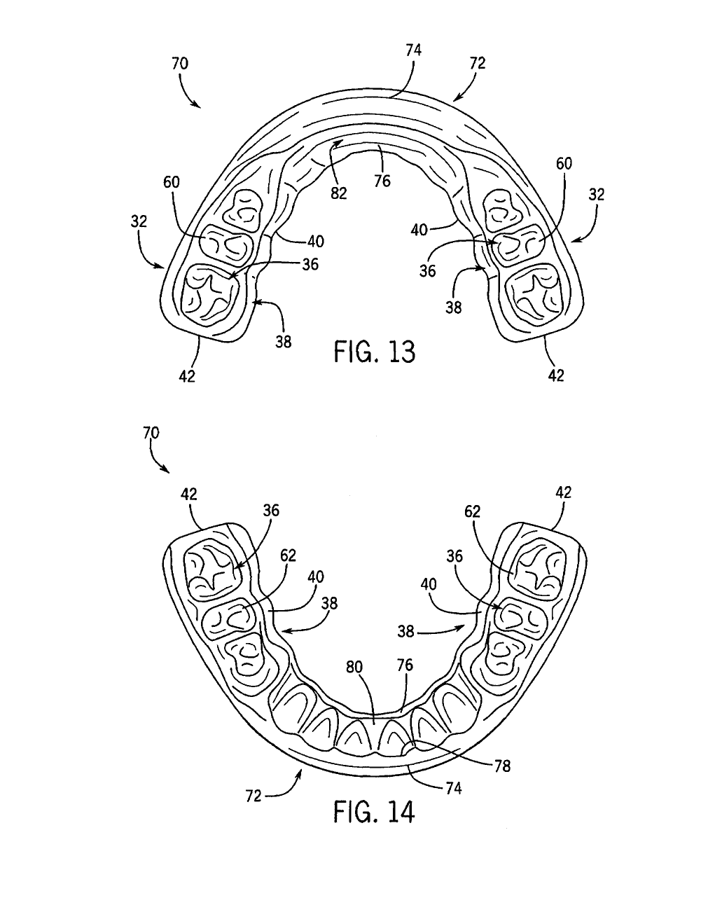

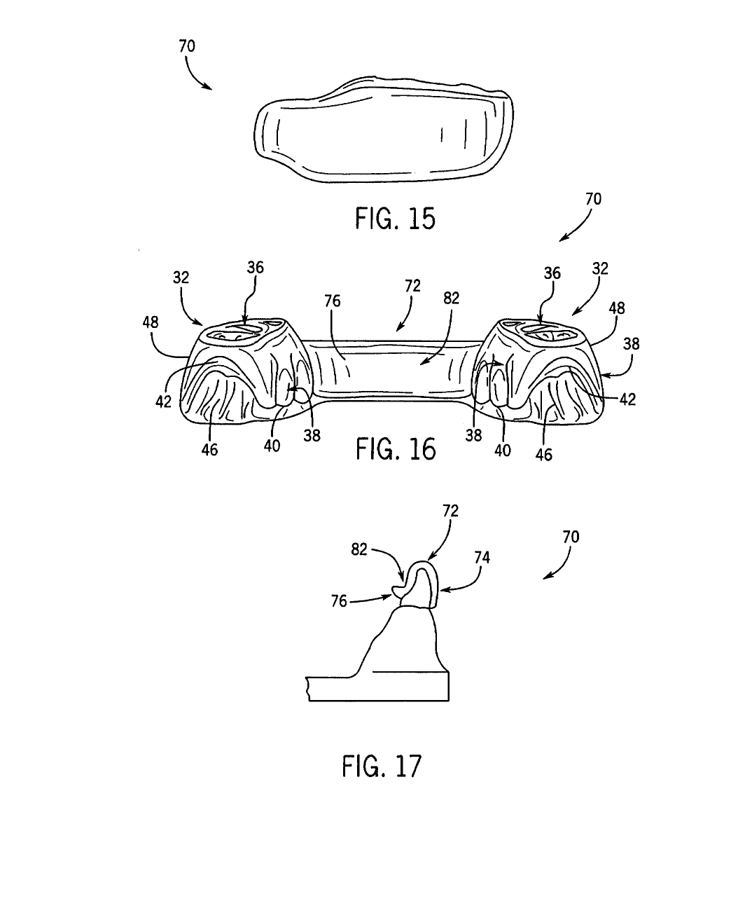

FIGS. 11-17 show another example of a lower bite regulator constructed in accordance with the teachings of the present disclosure. In this example, the lower bite regulator is constructed essentially the same as the prior described lower bite regulator except in the region of the labial band. In this example, like reference numerals refer to like parts of the lower bite regulator 30. In this example, the lower bite regulator is referred to as a hybrid lower bite regulator 70 because it provides some mouth guard functionality. Specifically, the hybrid lower bite regulator has a front band 72 with a labial wall 74 and a lingual wall 76 that replaces the labial band 34 of the above-described lower bite regulator 30. The front band 72 in this example is configured to fully cover both the labial side and lingual side of the wearer's front teeth and thus is generally U-shaped in cross-section and extends over the top edge of the front teeth. See FIG. 17.

The lingual wall 76 can be a continuation of the molar section lingual walls 38 and labial walls and the labial wall 74 can be substantially similar to the labial band 34 of the prior example. The interior surface 78 of the labial wall 74 and the interior surface 80 of the lingual wall 76 of the front band 134 in this example are each custom fitted and contoured to match the labial and lingual surface contours of the wearer's teeth. The lingual wall 76 of the front band 70 can again have a substantially thin wall thickness and can be contoured to minimize obstruction with the front of the wearer's tongue during use.

The lingual wall 76 can optionally be provided with a tongue shelf 82 that aligns with the earlier described tongue shelves 56 on the molar sections 32 to further assist in locating the wearer's tongue in a natural position while wearing the device. Alternatively, the lingual wall 76 of the front band 72 in this example can have a bottom edge that terminates above the soft tissue or gum line of the wearer and/or is contoured so as to not contact any soft tissue or otherwise overlap the gum line of the wearer. Such a limited lingual wall would likely not accommodate much of a tongue shelf. The labial or outer facing surface of the labial wall 74 in this example can be smooth or again can be contoured if desired. Providing a smooth outer surface would allow for increased wall thickness on the labial side of the labial band, which can offer better tooth protection and, thus, mouth guard functionality. This may be desirable in some circumstances because the device is a hybrid device configured to cover both sides of the front teeth and may be specifically intended to offer some mouth guard functionality.

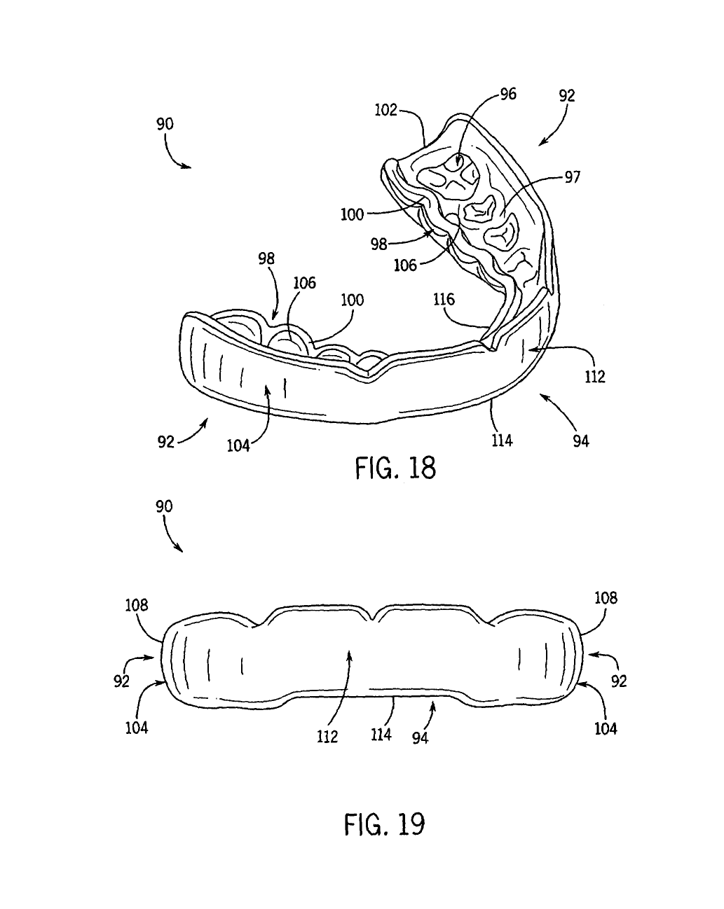

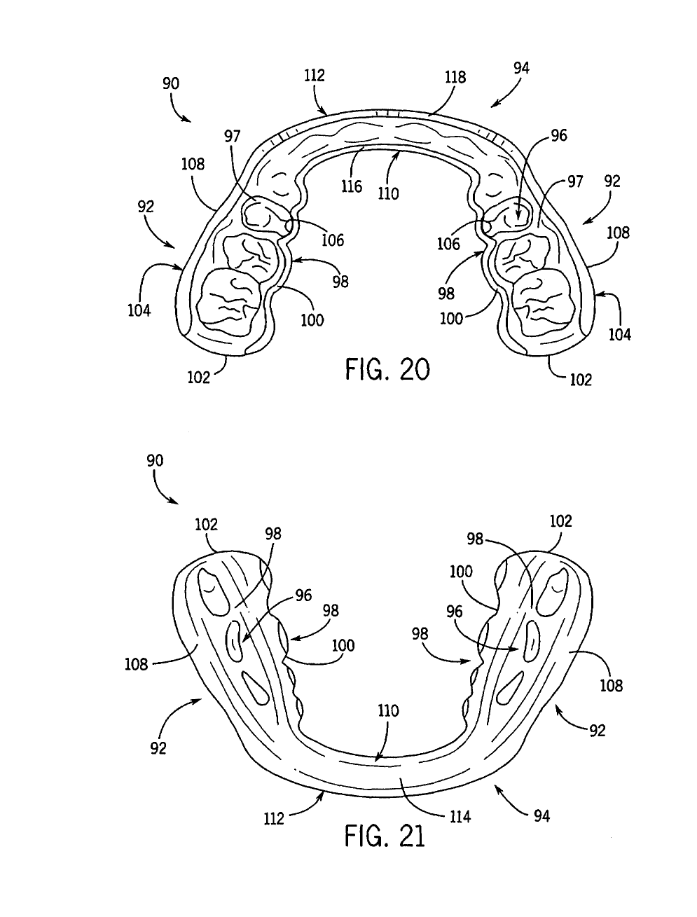

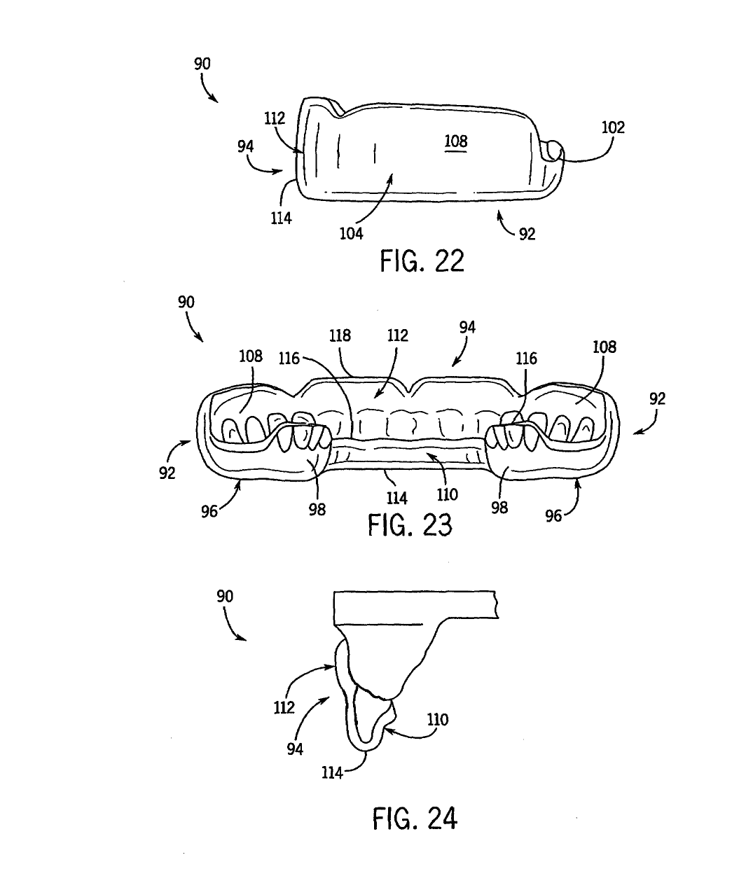

FIGS. 18-23 show another example of a bite regulator constructed in accordance with teaching of the present disclosure. In this example, the oral appliance is configured as an upper bite regulator 90 and is to be received on and conform to the upper teeth of a wearer and not the lower teeth. In general, the upper bite regulator 90 is configured similar to the earlier described lower bite regulator 30 and hybrid lower bite regulator 70, but is more similar to the lower hybrid bite regulator in that it functions in part as a protective mouth guard. The upper bite regulator 90 has left and right molar sections 92 that have essentially the same construction as the earlier described molar sections 32. However, no tongue shelf is provided as the tongue would not be in contact with the upper device. The molar sections 92 are connected to one another by a front band 94 with left and right ends connected to the molar sections 92. Each molar section 92 has a thick interocclusal region 96 that would be positioned between the upper and lower molars of a wearer. Each molar section 92 has a top surface 97 and a bottom surface 99 that are again molded to match the contour of the wearer's upper and lower molars.

The molar sections each have a lingual wall 98 extending up from an inner edge. The lingual walls 98 can have a bottom edge 100 that is contoured to not touch, overlap, or otherwise contact the soft tissue of a wearer. The lingual walls are also contoured (both inside/tooth facing side and outside/tongue facing side surfaces) to match the contour of the adjacent molars. The molar sections 92 also can each have a rear lip 102 that protrudes up from a rearward most free end of the molar sections. Each molar section 92 also has a buccal wall 104 protruding up from an outside edge of the molar section. The inside or teeth facing surfaces 106, 108, respectively, of the lingual and buccal walls 98, 104 can be contoured to match that of a specific wearer or subject, as with the previous examples. The molar sections 92 are again designed to terminate at the third molar, not the fourth or rearmost molar and the rear lip is intended to lay against a rear surface of the third molar and reside between the third and fourth molars.

The primary difference between the upper bite regulator 90 and the lower models described above is that the upper bite regulator is configured to fit over the upper teeth of the wearer. Also, the front band 94 can be configured to provide added dental coverage and protection, imparting the addition of mouth guard functionality to the device. The front band 94 in this example can have a lingual wall 110 and a labial wall 112 joined to one another at a bottom edge 114, similar to the hybrid lower bite regulator 70, but for the upper front teeth. The lingual wall 110 can have a substantially thin wall thickness and can be contoured to match the lingual face contour of the wearer's teeth. The bottom edge 114 of the front band 94 in this example is intended to wrap around the lower edge of the wearer's upper front teeth. See FIG. 24. An upper edge 116 of the lingual wall 110 on the front band 94 can be contoured so as not to contact the soft tissue or otherwise overlap any portion of the wearer' gum line. An outer or labial surface 118 of the labial wall 112 on the front band 94 in this example can be smooth so as to allow for a more robust wall thickness covering the wearer's front teeth to enhance the mouth guard functionality of the device. The labial wall 112 can also extend upward and cover a good or substantial portion of the soft tissue or gums above over the wearer's front teeth.

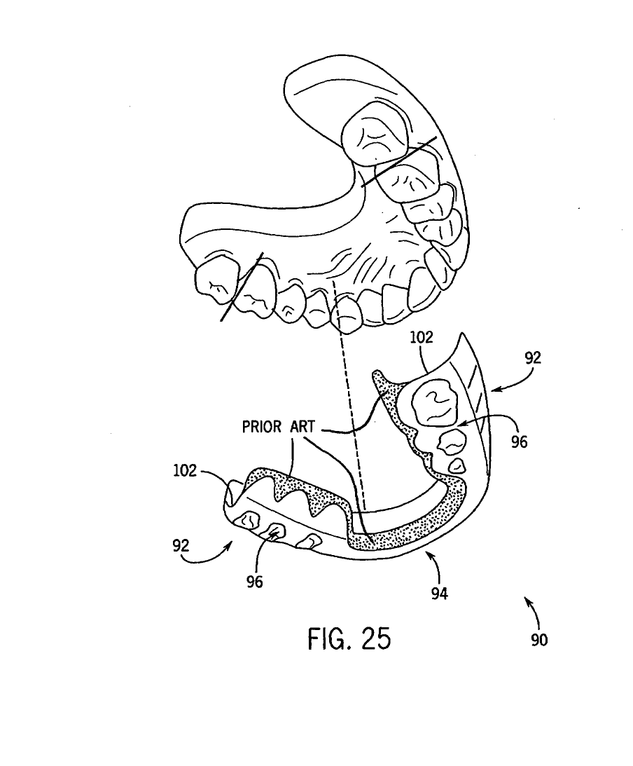

FIG. 25 shows a comparison of the upper bite regulator 90 to a more conventional oral appliance of mouth guard construction. The dark areas in the drawing represent material found on the conventional device that is eliminated on the upper bite guard 90. The height of the material on the lingual wall and/or the labial wall of the front band 94 can vary. The front band 94 can alternatively be similar to the front or labial band described above on the lower bite regular of FIGS. 1-6.

On the hybrid lower bite regulator and the upper bite regulator, the interocclusal portions 36, 96 of the molar sections 32, 92 again have a much thicker wall thickness to provide impact protection. The top surfaces 60, 97 and underside or bottom surfaces 62, 99 of the respective occlusal regions 36, 96 of the molar sections 32, 92 are also custom fitted, molded, and bite registered to provide the bite registration noted above and described further below.

The disclosed bite regulator models offer high performance as a custom mouth piece. The disclosed bite regulator models are light, flexible, custom fitted polymer thermoplastic mouth pieces that perfectly regulate a person's bite to provide enhanced breathing, clear communication, and proper skeletal alignment, even during high impact and high stress activities and in such environments. The increase in oxygen naturally increases both performance and protection by allowing athletes to train harder, recover faster, react quicker, avoid fatigue longer, and maintain a steady flow of oxygen to the brain to make better decisions and take action when it matters most.

The PX3 bite regulators are proven to increase oxygen volume, dopamine levels, heart rate variability and reduce concussions. Numerous institutional tests and studies to date have proven that the superior performance of the bite regulators.

The fundamental principles of the disclosed bite regulators are: greater oxygen equals greater performance equals greater protection. No other such device or product has previously been designed, fitted or custom manufactured like PX3 bite regulators, and no other such device has been able to produce scientifically proven results like PX3 bite regulators. The PX3 bite regulators disclosed herein are proven performance enhancing mouth pieces or oral appliances that achieve real, consistent, and measureable results with all athletes and body types during high impact activities and in high stress environments. It is well researched and documented that oxygen levels and brain function go hand in hand, affecting motor skills, vision, hearing, reaction time, strength, flexibility, balance, the ability to learn, heal, and protect, plus thousands of other neurological responses. It is very well researched and documented that jaw position affects the flow of oxygen to the body. CPR training and certification instructs people to bring the patient's jaw forward to open up the airway. You would never push the jaw back in the throat, or move it all the way to the left or right without significantly occluding the airway. It is also very well researched and documented that a person's physiological state directly affects their ability to perform tasks, and their risk of injury to themselves or to others. This is why there are strict time schedules with airline pilots and commercial truck drivers, and why drinking and driving laws are in place—when a person's physiological state is deficient, they are more prone to hurt themselves and others.

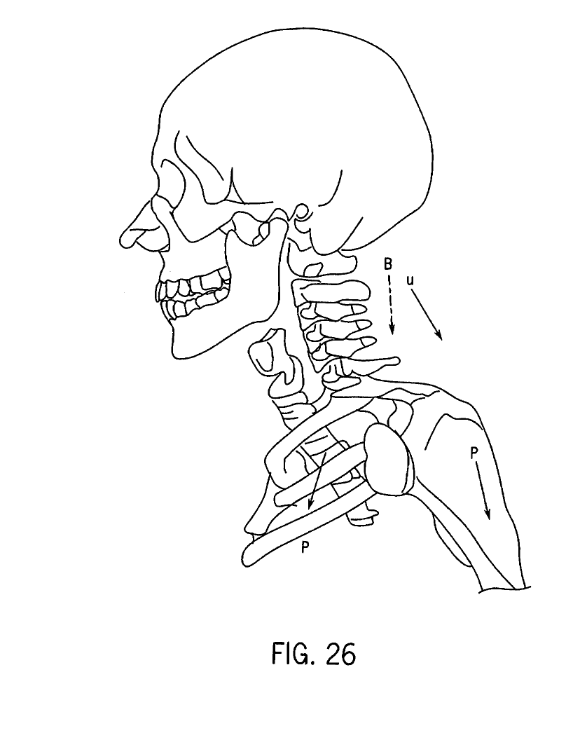

FIG. 26 shows the skull and neck of a person with arrows depicting how jaw misalignment can negatively affect performance. Neck and back tension begin with an unbalanced bite. With good posture, one's head exerts an 8-16 pound pull on the neck muscles in the direction of the arrows P. The arrow B shows the force direction exerted when the person's bite is correctly aligned and balanced. The arrow U shows the force direction exerted when the person's bite is incorrect and out of balance. Under such unbalanced conditions, the head can exert a 30 pound pull force on the neck muscles causing strain and tension.

In sports, the jaw is always in motion and never stabilized. In high impact sports, the jaw is constantly being knocked around and misaligned through impact. Regardless of impact, even just with a high stress environment, the natural tendency for people is to clench down and stop breathing all together. Regardless of high impact or high stress, daily life creates repetitive stressors, which drive chronic, low-level survival responses. Over time, this process builds up, and can contribute to suboptimal performance, chronic fatigue and poor health. PX3 bite regulators, by maintaining and enhancing oxygen exchange, prevent this negative process from happening.

Knowing the role that the jaw plays and how important oxygen is to overall human function, the disclosed PX3 bite regulators have been developed to capture a person's unique and optimal breathing position and regulate the jaw in that position so that it prevents it from sliding or causing postural skeletal misalignment during high impact and high stress environments. In sports, these are typically the most crucial moments when success and failure truly matter most. In other areas of life, such as in hostile military combat, these moments are when success and survivability are defined.

The disclosed bite regulators have been developed to enhance a person's power, performance, recovery and prevention. The bite regulators have been extensively tested and developed in the most extreme high performance environments in the world. The bite regulators significantly advance this field in three key areas:

1. Reducing the risk of injuries and disease.

2. Naturally increasing human performance to eliminate the need for Illegal Performance Enhancing Drugs.

3. Increasing brain and body performance and overall health.

The PX3 research council is one of the most comprehensive in sports and is made up of leading Neurologists, Physiologists, Kinesiologists, Medical Doctors, Chiropractors, Dentists, Athletic and Military Special Ops trainers, and the like. The bite regulators that have been developed have surpassed expectations in performance in these key areas.

The lower bite regulator 30 is custom fitted to lower teeth and is best in class for quality, comfort, and durability. The lower bite regulator 30 offers the highest volume of oxygen increase for these types of products. The lower bite regulator 30 also offers the clearest ability to communicate while wearing the device. The tongue is left free to move so that a wearer can speak nearly normally, even with their jaw clamped down on the device. The lower bite regulator 30 is designed for all sports, training, and physical activities where full dental coverage is not mandated.

The lower hybrid bite regulator 70 provides full dental coverage of the lower teeth for contact sports that require mouth guards while still providing all of the characteristics and benefits of the lower bite regulator 30. The lower hybrid bite regulator 70 is designed specifically for youth contact sports, such as football, ice hockey, lacrosse and field hockey, where mouth wear that provides full dental coverage of either the top or bottom teeth is mandated, but where the athletes have additional facial protection provided by the sport specific head gear. The upper hybrid bite regulator 90 provides full dental coverage of the upper teeth for contact sports that require or mandate full dental protection while still also providing all of the performance characteristics and benefits of the lower bite regulator 30.

Each of the bite regulator models is contoured on the lingual side, cut out around each individual tooth to have minimal or no contact with the lingual soft tissue. The lower and lower hybrid models can also have the added feature of additional contouring to include the tongue shelf for additional airway opening. The smooth outside or labial surface contouring can be important for long-term use and overall comfort. The thin wall thickness and contouring on the lingual walls and surfaces are also important for long term us, very comfortable fit, and increased ability to speak and breathe while wearing the device.

Tongue position can significantly affect one's airway. When the tongue comes into contact with anything in the mouth, it has been shown to naturally retract back into the throat, which occludes the airway. The tongue shelf on the lower models allows the tongue to push forward and rest comfortably, opening the air way and resting tongue muscles. The labial band or front band on the lower and lower hybrid bite regulator models comes up off the front gums and rests only on the teeth for added comfort and extended wear.

The bite regulators have been tested and proven to enhance respiratory, physiological, and neurological performance. Every single millimeter of material and degree of bite position vertically, horizontally and sagittally on these types of devices has been found by the patentee to make a profound and instant difference in performance efficiency and comfort. The disclosed bite regulators are unique and benefit from highly skilled and trained lab technicians, state-of-the-art tools and technology for fabricating and fitting the devices.

The disclosed bite regulators greatly enhance performance by perfectly contouring the lingual side (upper and lower models) so as to stop at and follow the natural/unique tooth/gum line (vertical up and down) and by factoring in the natural/unique contours of the patient's teeth (horizontal in and out/side to side). On the lower bite regulator, the labial band is cut away almost completely, just barely covering the front 6 teeth. All models only go as far back as the first molar. On the lower guards, the tongue shelf maximizes air flow through optimized tongue alignment.

According to the Centers for Disease Control, as many as 3.8 million athletes suffer a concussion each year in the US. Even more alarming, traumatic brain injury (TBI) is the leading cause of death and disability in persons under 45 years old, occurring more frequently than breast cancer, AIDS, multiple sclerosis, and spinal cord injury combined. Other equally revealing statistics are that:

Brain injury is suffered by someone in America, usually a young person, every 15 seconds;

Each year, approximately 100,000 people die from TBI and 500,000 more are permanently disabled;

80,000 people experience the onset of long-term disability following a severe brain injury annually; and

The cost of treating, rehabilitating and caring for the victims of traumatic brain injury costs the U.S. over $50 billion each year.

Concussion testing and research are focused on the equipment and force or impact levels. It is also well researched and documented that mouth guards have little effect in reducing concussions or the severity of concussions from an impact.

It is also well documented that most injuries happen in the second half of the game, and the second half of the season. It is also well documented that drinking and driving a vehicle at any speed, regardless of wearing a seatbelt or not, is illegal. This has driven the patentee to reevaluate the concussion issue. The patentee has considered and determined that if the integrity of the protective equipment is constant, and that impact levels over the course of competition are constant, then the physical and mental state of the athlete must be the major variable. Countless studies and programs continue to focus on the impact or acceleration forces for a possible solution. The patentee has also realized that if we only measured impact or acceleration forces in a drunk driving accident, the information on how the accident happened would not be relevant as they have occurred at every rate of speed from 5 mph to 200 mph. Without considering the physical and mental state of driver they will never fully account for why the accident happened or ever find a solution in how to reduce the risk of this happening again in the future.

The patentee has noted that mouthguards restrict breathing and misalign the jaw. This requires more energy to function, wears athletes down faster, making them less efficient and increasing the risks of concussions and permanent injury. In the most recent concussion study with mouthguards, it was noted that in some cases they found the use of mouthguards increased the frequency of concussions. The patentee's research clearly shows how mouthguards restrict breathing and negatively impact the athletes' physiological state. Using very basic kinesiology testing, the patentee has also clearly shown how athletes are instantly weaker from a strength, balance, and flexibility standpoint. Mouthguards, even custom fitted mouthguards, appear to the patentee to be a bigger part of the problem than anyone has heretofore realized. The disclosed bite regulators are not mouthguards. In fact, they are the exact opposite from a neurological and physiological performance standpoint in the proven fact that the bite regulators enhance these factors rather than limit or restrict them.

The disclosed bite regulators are also not therapeutic orthotic devices. Therapeutic orthotic devices are designed to treat disorders or relieve pain. Such devices are not designed for unobstructed breathing or communication, are not used in high impact athletic or military environments, and are not proven to increase human performance or reduce brain injuries. Orthotics are positioned where all masticatory muscles, including all antagonistic muscle groups, such as elevators and depressors, are in the state of minimal electrical activity necessary to maintain postural rest. Many custom splints provide vertical spacing, but do not account for, align or stabilize symmetrical vertical, sagittal and horizontal position of the jaw. Orthotic of this level of quality and detail are only available through certified dentists.

The disclosed bite regulators are designed to provide proper symmetry in the mid-face and offer an enhanced voluntary bite position to increase breathing and optimize physiological and neurological performance among all body and jaw types. The 3-dimensional fitting process for the disclosed bite regulators allows the mouth pieces to be self-fitted by any individual or professionally fitted by any certified dentist, in any country in the world, in about 15 minutes or less.

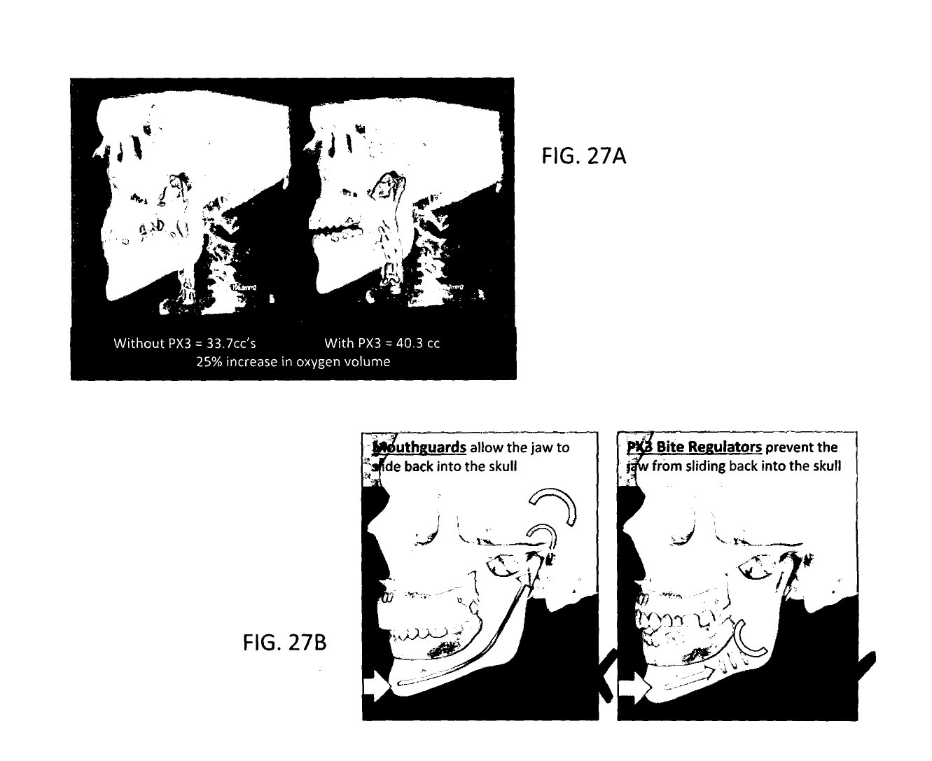

The patentee has developed a unique X-Y-Z quadrant fitting system that pinpoints each athlete's or user's unique vertical, horizontal, and sagittal mandible position. This unique 3-dimensional position can then be used to create a customized occlusal opening and jaw position that naturally and symmetrically aligns the jaw for optimized respiratory, skeletal, muscular, physiological, and neurological function. The disclosed fitting system is then used to custom manufacture the aforementioned bite regulators to achieve these benefits. Each bite regulator is a fully customized mouth piece that enhances postural alignment. Each mouth piece also increases the airway opening (see FIG. 27A) and stabilizes the jaw (see FIG. 27B) during high impact and high stress activities and situations.

According to the teachings of the present invention, a self-impression process for custom fitting the disclosed bite regulators can take less than 15 minutes. In one example, a custom manufacturing and self-impression series or system kit can be provided directly to a user or subject to be fitted. The user can then custom fit the regulators to a specific subject. As used herein, the term “subject” or “person” may refer to the athlete or individual intending to be custom fitted for a bite regulator. The term “user” may refer to a person assisting a subject with the self-impression, custom fitting process. The user can be a dentist, dental technician, bite regulator fabrication technician, or any third party assistant. The user may also be the subject where the subject is undertaking a pure self-impression process.

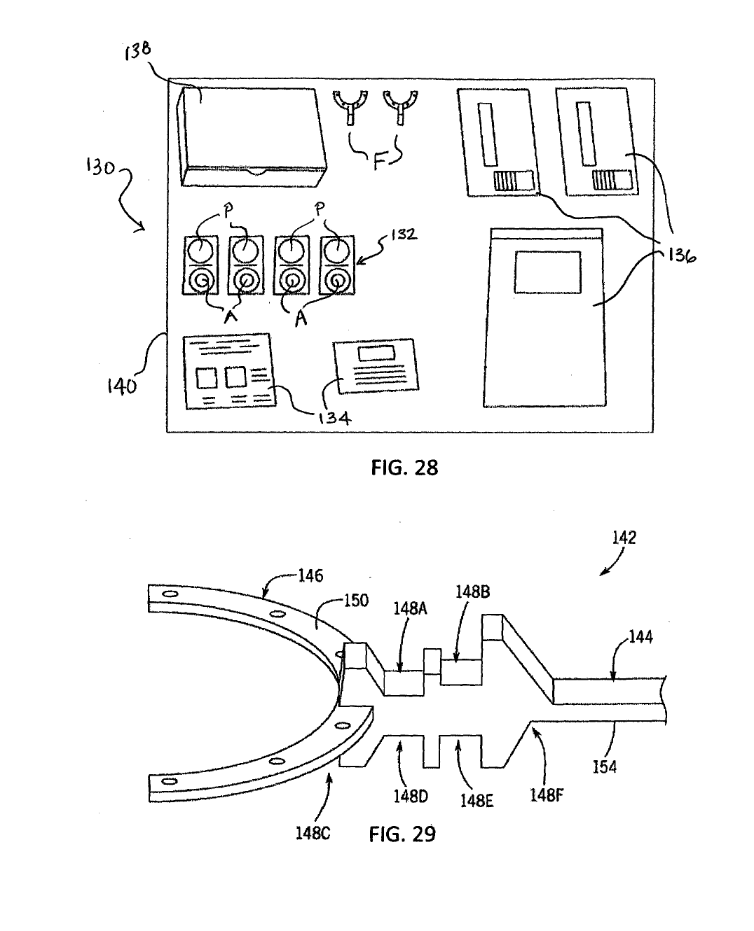

A self-impression kit assembled in accordance with the teachings of the present invention is shown in FIG. 28. In one example, the kit 130 can include two or more packages 132 of impression putty P that is used to take the critical impressions of the person's teeth. The kit 130 can also include instructions 134 and one or more shipping bags 136 and/or boxes or containers 138 for purposes described below. In accordance with the teachings of the present invention, the kit 130 can also be provided with one or more bite simulators or dental impression bite registration tools F that can be used to specifically determine and record the bite registry of the subject either taking their own impressions or being assisted with the process. The kit 130 can be provided directly to the subject or to a user (i.e., professional, technician, etc.) by mail, courier, or the like and can be packaged in a single container 140, similar to the container 138 shown in FIG. 28.

The size, shape, form, and quantity of the elements of the kit 130 as depicted in FIG. 28 can vary. These variables can depend on any number of factors. In one example, individual or multiple kit orders can be packaged and shipped or delivered in a single container. As will become evident upon reading this disclosure, the type and number of packages 132 of impression material P and dental impression bite registration tools F in a given kit can vary. The disclosed self-impression system kit 130 is not intended to be limited to the elements or components of the kit shown and described with respect to FIG. 28. However, the self-impression system kit 130 should have all of the items necessary for proper custom fitting of the bite regulators. Each kit 130 should also include impression material P in various quantities sufficient to properly register the full anatomy of the subject's teeth, bite registration, and gums. The kit can include additional putty packs 132 to account for errors by the user or by the subject when taking their own impression. The kit can also include additional packs 132 of impression material P so the user or subject can take multiple sets of impressions that can be provided to a designated lab for fabrication. Having multiple impression sets may provide the fabricator of the bite regulators a back-up or redundant information in case there is a problem with any one portion or region in one of the impression sets.

In one example, a kit 130 can be delivered direct to a subject. The subject can follow the instructions 134 and take a self-impression of their teeth and gums as described below. In another example, such a self-impression series kit 130, or the elements and components of such kits can be provided to, provided by, or housed by a professional. The professional can then provide the components of the kit, as needed, to custom fit the regulators for each specific subject. The person or subject intending to get fitted for a bite regulator as disclosed and described herein can visit the professional facility, either a dentist or a dedicated fitting facility, where a professional will conduct the fitting, take impressions, determine the bite registry, and the like, as described below. That facility can then either manufacture or fabricate a bite regulator on-site, if capable, that is specifically fitted for that person, or can send the various impressions to a dedicated facility that manufactures the bite regulators. Dentists can become certified and trained to perform the various fitting techniques so that the correct jaw alignment can be determined for each individual subject. Dentists can also offer advanced fitting techniques for patients that have orthodontics or suffer from severe jaw disorders or disfiguration.

As noted above, the configuration and construction of the dental impression bite registration tools F can vary. The dental impression bite registration tools of the self-impression kit 130 are referenced herein by the letter F when referring generically to the bite registry tool or tools provided with the kit. As described below, the configuration and construction of the dental impression bite registration tool or forks F can vary. FIG. 29 illustrates one example of a tool in the form of a bite fork 142 that can be used in accordance with the teachings of the invention to determine each person's proper jaw alignment and natural jaw position. The bite fork 142 has a handle 144 at one end and an arcuate or curved section 146 connected to the handle. The curved section 146 is configured to be received in the person's mouth during use. The bite fork 142 also has a plurality of notches 148a-f formed on both the top side 150 of the fork between the handle 144 and the curved section 146 and on the bottom side 152 as well. The top side 150 includes two notches 148a, 148b in this example for providing two different landing locations for a user to place their upper teeth. The bottom side includes four notches or landing zones 148c, 148d, 148e, and 148f in which the user can place their lower teeth. The user can determine their correct or natural bite, whether it is a normal bite, an underbite, or an overbite and can use the various notches to find the most natural jaw position.

Each of the upper notches is also spaced at a different vertical distance to the lower notches in this example. The user or subject can thus also determine the subject's upper to lower jaw spacing position that is most comfortable. In one example, the spacing between the upper and lower notches can be 3.5 mm for one of the upper notches and 4.0 mm for the other of the upper notches. A range of different thickness dental impression bite registration tools F can also optionally be provided with a kit 130. A range of the dental impression bite registration tools F or bite fork 142 could be provided with the kit 130 and each can have a curved section 146 of a different thickness. Such a range of dental impression bite registration bite forks F or bite fork 142 may accommodate, in one example, between a 0.5 mm vertical opening to a 8.0 mm vertical opening. Other examples are certainly possible.

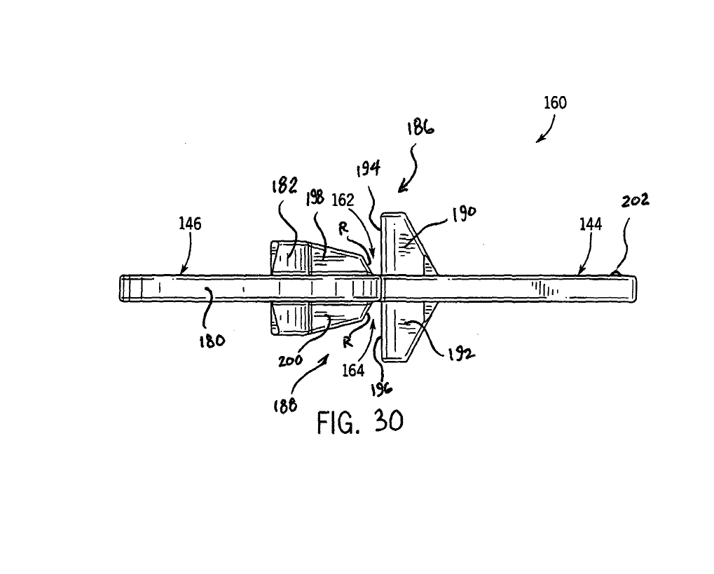

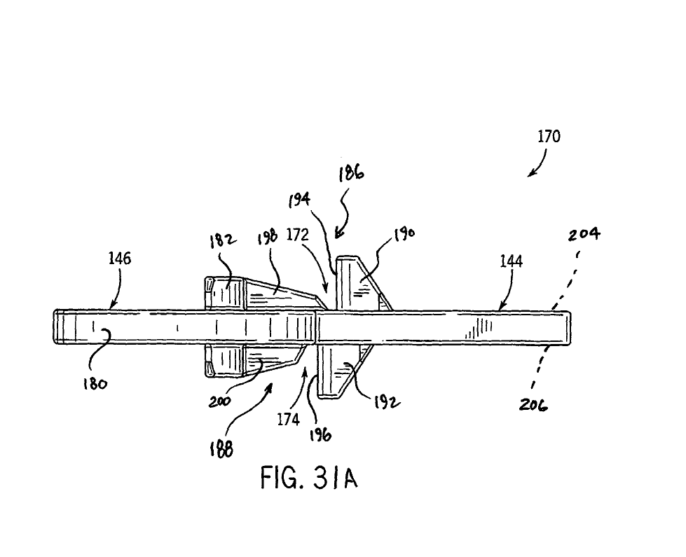

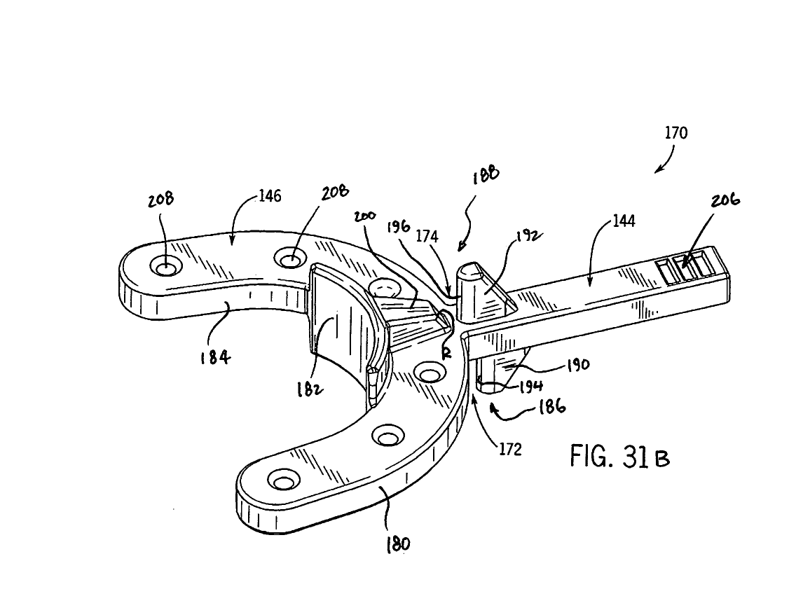

FIGS. 30 and 31A show alternative examples of dental impression bite registration tools that may be provided with a self-impression system kit 130. FIG. 30 shows a Class I bite fork 160 with a handle 144 and a curved section 146, similar to the bite fork 142. The dental impression bite registration bite fork 160 has a single upper notch 162 and a single lower notch 164 that are generally vertically aligned with one another. The Class I bite fork 160 is configured to accommodate people having a relatively normal or vertically aligned bite. FIG. 31A shows a dental impression bite registration bite fork 170 that similarly includes a handle 144 and a curved section 146. The dental impression bite registration bite fork 170 is configured to accommodate more severe overbite and underbite malocclusal classes, i.e., Class II/Class III malocclusal conditions. The dental impression bite registration bite fork 170 has one upper notch 172 and one lower notch 174 that are vertically misaligned or offset relative to one another in a fore and aft direction. In FIG. 31A, the bite fork 170 is oriented to accommodate a Class II overbite.

In FIG. 31B, the same dental impression bite registration bite fork 170 is flipped over to accommodate a Class III under-bite. The dental impression bite registration bite forks 160 and 170 can also be provided in a range of thicknesses, as described above as an option for the bite fork 142, so that the subject can find their optimal jaw/bite opening. A series of the dental impression bite registration bite forks 160, 170, as well as the bite fork 142, can also be provided whereby each fork in the range has a range of different vertical misalignments between the notches, if desired. As will become evident to those having ordinary skill in the art, the features of the dental impression bite registration tools can be modified to accommodate a wide range of individuals. The goal is to provide a tool for the user to determine their natural bite and jaw position, which in turn can be used in order to create a bite regulator that accommodates the subject's natural jaw position both fore-aft and vertically.

Though not shown herein, the intended user may have braces. The self-impression system kit 130 can be provided with protective wax that can be placed over the user's braces to cover the braces prior to taking the impressions. The wax can help to protect the braces from the impression material and to release the impression material from the subject's teeth and braces when the impressions are completed and the material is removed from their mouth.

Using the self-impression series kit 130, an athlete or other user or subject can readily perform the various steps required for custom fitting a bite regulator as described above. The instructions 134 can be designed to walk the subject step-by-step through the entire process on their own. In one example, the instructions can be provided with the kit 130 in paper form with text and pictures. In another example, the instructions can be provided on another form or media in the kit, such as on a flash drive device, an audio disc, a video disc, or the like. The instructions can be entirely in still image form, with or without text, or can be in entirely audio form, or in video form, if desired. In another example, the instructions can be provided as a downloadable app for an electronic device such as a computer, smart phone, tablet, or the like. In another example, the instructions can be provided via a web link and accessible on a third party server using the interne. In each case, the instructions can be provided so as to guide a user or subject through the custom fitting process.

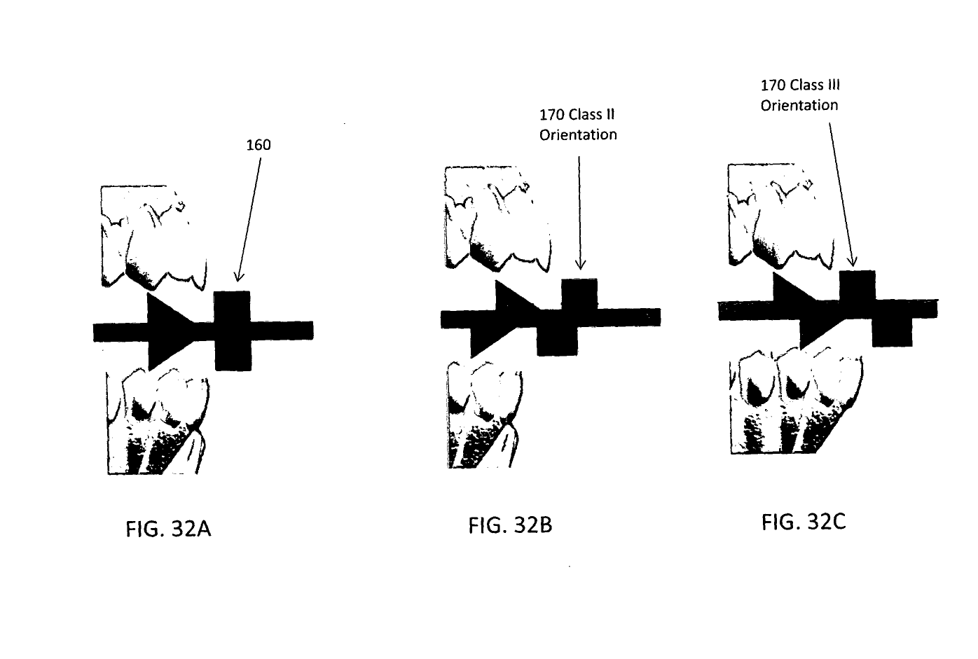

With reference to FIGS. 32A-32C, the self-impression system kit 130, and thus the instructions 134 are designed to first assist a user or a subject in determining the particular type of bite for the subject. Over 98% of the population suffers from some form of bite misalignment or malocclusion. There are three basic classifications, which are illustrated using a form of the bite forks 160, 170 described above. These are based on the position of a subject's front teeth (anteriors—incisors and cuspids) and top first molar in relation to the rest of the teeth, while in a normal bite position. The user or subject may be instructed to test and select the correct dental impression bite registration tool F from the kit 130 or use a lone provided dental impression bite registration tool, such as the bite fork 142, to test different jaw positions via trial and error.

A Class I bite is a normal bite where the overjet or overbite of the front upper and lower incisors is within about 1 mm or less in the fore-aft direction. For this bite, the Class I fork 160 is used, as shown in FIG. 32A. A Class II bite is where the overbite or overjet of the front upper incisors is about 3 mm or greater than the lower teeth in the fore-aft direction. For this bite, the Class II side of the bite fork 170 is used, as shown in FIG. 32B. A Class III bite is where the underbite of the front upper incisors relative to the lower teeth is about 3 mm or greater in the fore-aft direction. The Class III side of the bite fork 170 is used for this bite, as shown in FIG. 32C.

The user can determine their bite type roughly by looking in a mirror. For this step, the subject or user can then take the perceived correct dental impression bite registration tool and test whether their initial assumption is correct. For a perceived normal bite, the user or subject can select the Class I bite fork 160 from the kit 130, as shown in FIG. 32A. The bite fork has notches 162, 164 that generally align with one another, allowing for a bit of fore-aft play to accommodate slight variation from user to user within the normal range. One surface R of each notch 162, 164 can be ramped to guide the subject's teeth fully into the notches and to the correct position. For a Class II bite, the user or subject can select the other bite fork of this example, i.e., the Class II/III bite fork 170 from the kit 130 and orient the bite fork in the Class II orientation as shown in FIG. 32B. In this orientation, the notches 172, 174 are positioned for an overbite, putting the upper teeth forward of the lower teeth. For a Class III bite, the user or subject can select the Class II/III bite fork 170 and orient the bite fork in the Class III orientation as shown in FIG. 32C. In this orientation, the notches 174, 172 are positioned for an underbite, putting the upper teeth rearward of the lower teeth. The Class notches in this example are vertically misaligned by about 2.5 mm. However, the amount of offset for the notches can be greater or lesser, if desired.

The step to determine the bite type of the subject can take less than 3 minutes. Trial and error might be necessary to find the most comfortable, i.e., correct jaw position. The user must first determine their most comfortable jaw position, and spacing, if the aforementioned bite fork 142 is utilized or if multiple thicknesses of dental impression bite registration tools F are provided. The user can practice by placing their teeth in various ones of the dental impression bite registration tools and/or notch options. For each trial, the person can be instructed to perform simple physiological tests, to check their breathing, and the like in order to determine the best position for them.

The instructions 134 may then instruct the subject to make sure their teeth are clean, such as by brushing and flossing their teeth. The instructions 134 may then instruct the user or subject to chill or cool one or more packages 132 of the impression material P by placing them in ice or cold water for a period of time, such as for at least five minutes, but no more than 20 minutes. This can be done before or while the subject cleans their teeth. Depending on the type of impression material used, the chilling step can take more or less time, or may not be necessary at all.

By first undertaking the foregoing steps, the bite type of the subject is determined and the proper dental impression bite registration tool F or notch combination in a particular fork is also determined for the subject's bite type. They are then prepared to move to the next step of the fitting process. The instructions 134 may then direct the user or subject to open a chilled package 132 and mix the setting agent A, if provided, with the impression material P. The impression material P may be worked and mixed to remove any bumps and bubbles from the material. This step may take 25-35 seconds in one example. The instructions 134 may then direct the user or subject to roll the impression material P into a ball and to compress the impression material in order to warm it up and remove any remaining cracks and bubbles. This step may take about 5-10 seconds in one example.

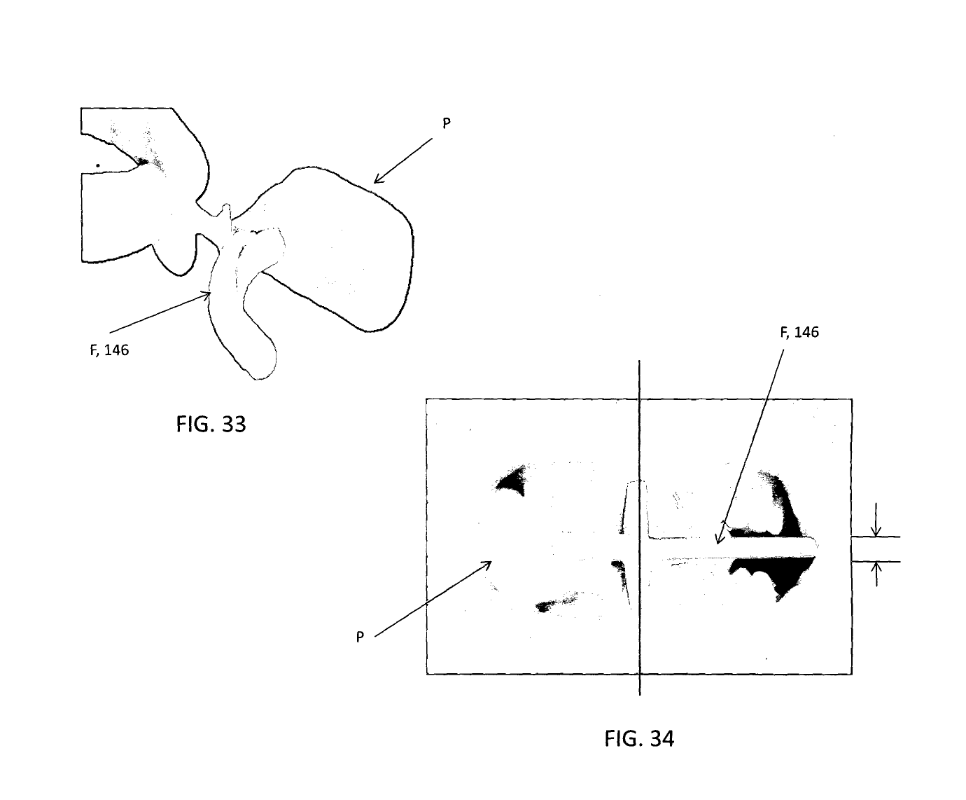

The instructions 134 may then direct the subject or user to take up the correct dental impression bite registration tool F, such as the bite fork 160 or 170, as used to determine the subject's specific, correct bite type. In one example, the instructions 134 may require the user or subject to prepare sufficient impression material P to take a full impression of the subject's teeth or to take a partial impression, such as one side of the subject's teeth. The prepared impression material P is then placed on either one side or on both sides of the curved section 146 of the dental impression bite registration tool F. In this example, the impression material P is placed on one side of the curved section 146 of the dental impression bite registration tool F, as shown in FIG. 33. The user or subject may be directed to make sure that sufficient impression material P covers all sides and surface of the dental impression bite registration tool or tool portion and that plenty of material is positioned in front of the soon to be formed channel where the subject's teeth will bite down on the fork. This step may take about 10-25 seconds.

Once the impression material P is in place on the dental impression bite registration tool F, the instructions 134 can direct the subject to stand in front of a mirror. The subject can then be instructed to place the dental impression bite registration tool F and the impression material P in their mouth. See FIG. 34. The subject can be instructed to keep or place their jaw in a symmetrical sagittal and horizontal directional bite position and then slowly bite into the impression material P and dental impression bite registration tool F, making sure their teeth land in the predetermined notch positions for the correct bite position. The fore-aft position of the subject's jaw will naturally and automatically register as a result of the natural positioning of the incisors in the predetermined notches on the dental impression bite registration tool F. The user or subject may be instructed to pull the dental impression bite registration tool F forward slightly and keep it level during this step in order to correctly position the 3-dimensional bite position. The subject should then hold this position for a time and allow the impression material P to set. This step can take about 2-5 minutes as set times are both impression material P and temperature sensitive. This step results in the first impression being taken of the one side of the subject's teeth and gives the correct fore-aft direction alignment of the subject's jaw in the process.

During this step, the instructions 134 may also direct the subject to ensure that the top middle teeth are aligned properly with the bottom middle teeth, as shown in FIG. 34. This can be done using the mirror and may result in stabilizing the jaw from side to side horizontal movement and misalignment. The desired, predetermined vertical spacing will be set by the thickness of the dental impression bite registration tool F between the subject's front teeth. The thickness of the dental impression bite registration tool between the front incisors can be designed to set a desired or an optimal sagittal position and/or vertical opening between the upper and lower teeth for the subject, as discussed above. See FIG. 34. In one example, the thickness range of the dental impression bite registration tools F can range from 0.5 mm to as much as 8.0 mm.

During this step, the instructions 134 can guide to subject and/or user to actively assist in taking a good impression of the subject's teeth and gums. For example, the subject may be instructed to use their tongue during this step to push impression material P to cover the insides of their teeth, including the back molars. The subject may also apply pressure with the tongue to cover their gums above and below their teeth on the inside or lingual side of their teeth. The user or subject may also be instructed to use their fingers to gently push the impression material P against the outside of their teeth and upward and downward over the gums above and below their teeth on the labial side. The subject may be instructed to close their mouth and lips to wet the impression material P, which can help make the impression material easier to move and sculpt. It can be beneficial to cover the gums completely to get the best usable impression. These steps can take about 30-40 seconds.

The instructions 134 may also guide the subject to close their mouth and suck the air and excess saliva out of their mouth. While doing so they can also be instructed to use finger pressure to press lightly against their cheeks and all around the gums. This can be done to ensure that the impression material P is precisely contoured to the user's teeth and gums to obtain a perfect impression. This step can take about 20-30 seconds.

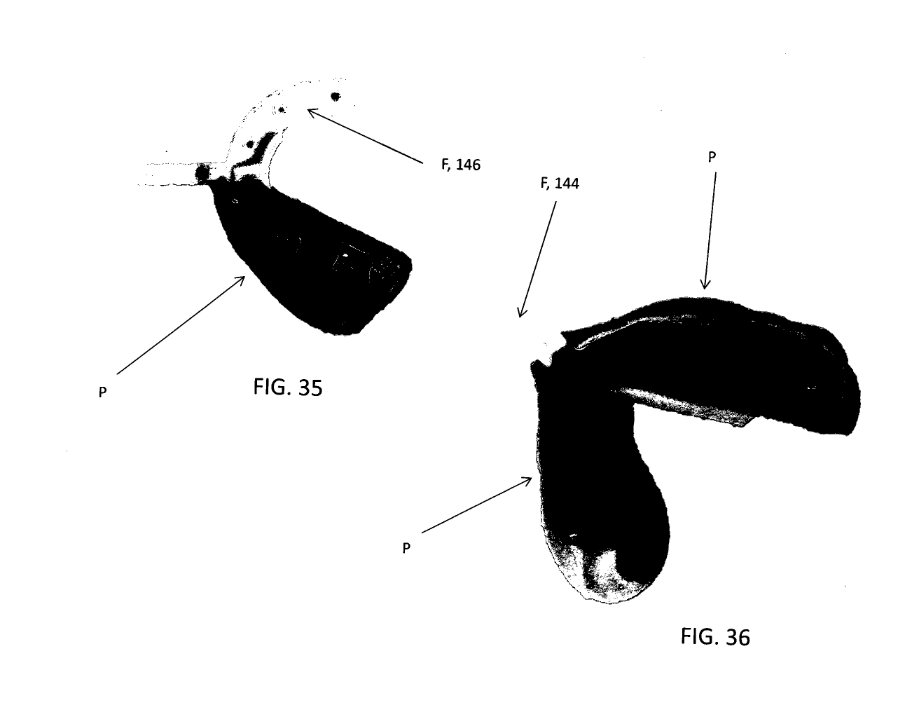

After these initial steps, and when the impression material P has set firmly, such as for about 2.5-5 minutes, the subject or user can remove the dental impression bite registration tool and contoured impression material P from the subject's mouth. As shown in FIG. 35 (bottom only), the impression material P on the dental impression bite registration tool F has a detailed impression of the subject's top and bottom teeth and a detailed impression of the subject's gums above and below their teeth. However, in this example, this is only for one side of the subject's teeth. The instructions 134 can then guide the user or subject to prepare to take an impression of the other side of their teeth. After extensive internal research and product development, the patentee has found that taking the impression in two steps instead of taking one full impression using the dental impression bite registration tools F yields the most consistent results and highest rate of success among non-dental trained individuals or subjects when taking the self-impressions. The patentee has also found that a two or three-step process using traditional impression trays and a single dental impression bite registration tool yield the most consistent results and has the highest rate of success among certified dentists. See co-pending U.S. application Ser. No. 14/216,191 filed Mar. 17, 2014, the contents of which are incorporated herein by reference. However, the process described herein can certainly be performed whereby a user or subject takes a full impression of the subject's teeth and gums in one step.

In this example, the instructions 134 can direct the subject or user to take up a second package 132 of impression material P and follow the same steps discussed above. They can mix the impression material ingredients and work the impression material P to remove bumps and bubbles. The subject or user can then roll the impression material to warm it and remove any remaining cracks and bubbles. This may again take about 25-35 seconds. The user or subject can then place the impression material P on the other or second side of the curved section 146 on the dental impression bite registration tool F of FIG. 35 in the same manner as discussed above with reference to FIG. 33. However, the instructions 134 can also guide the user or subject to ensure that the new impression material P on the second side of the dental impression bite registration tool F extends across the center of the dental impression bite registration tool and overlaps the earlier formed impression material on the first side. See FIG. 36. This may take about 10-20 seconds.

The instructions 134 can then direct the user or subject, when ready, to place the dental impression bite registration tool F of FIG. 36 back into their mouth. In order to preserve the first side impression of FIG. 35, the user or subject can be instructed to turn the dental impression bite registration tool F, putting the first side straight back into their mouth first. The user or subject can then be instructed to rotate the dental impression bite registration tool into the proper orientation and to then bite down slowly, closing the original impression side first and then closing the second new impression material side, as depicted in FIG. 37. This can ensure that the first side is fit precisely back in position so as not to damage the impression of the teeth on the first side. This step can also take about 10-15 seconds.

The instructions 134 may guide the subject to again use their tongue to push and contour the impression material P on the other lingual side of their teeth and gums. The impression material P will provide a superior impression if the impression material contours to their teeth and gums and covers all the way back to the rear molar on that side. The subject may also be instructed to close their lips to wet the impression material P. The user or subject can be instructed to apply finger pressure against the subject's cheeks to push and shape the impression material P along the side of their mouth so as to cover the labial surfaces of their teeth and gums on that second side. The subject or user can further be instructed use finger pressure to push the impression material P at the front of the subject's teeth. These steps can be prescribed so that the impression material P fully covers the subject's front teeth and gums and to blend the earlier impression material from the first set side with the impression material from the second side. The subject can again be instructed to close their mouth and suck excess air and saliva out of their mouth. While doing so, they can again be instructed to apply light pressure on their cheeks to be sure of full teeth and gum coverage. These steps can take about 30-45 seconds.

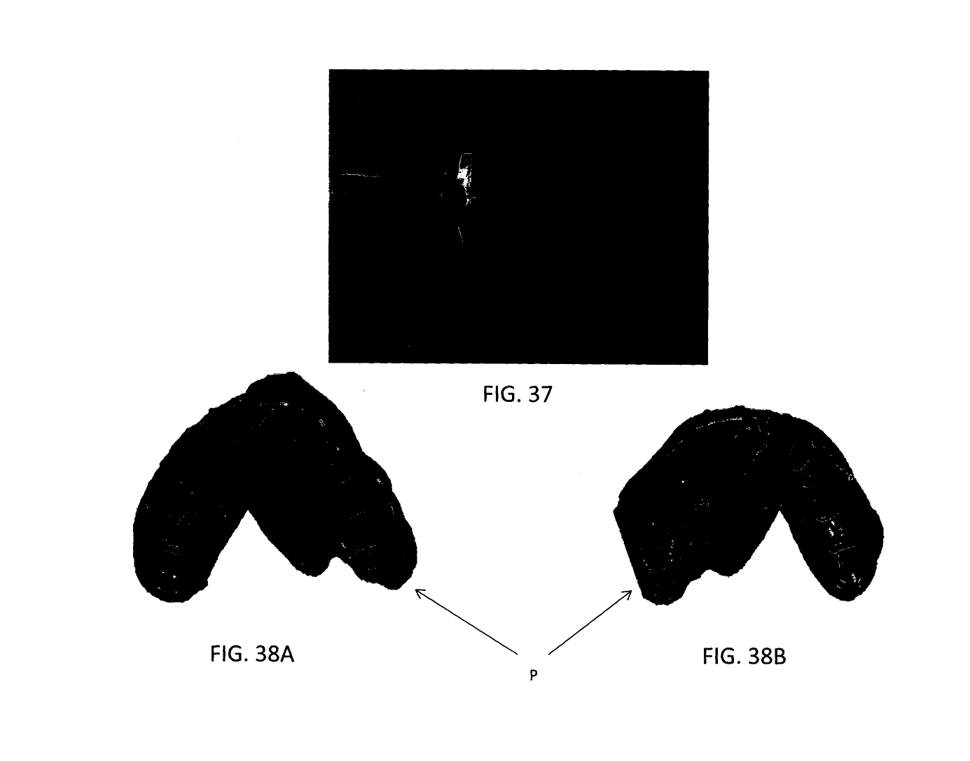

After these steps, and when the impression material P has again set firmly on the second side, such as for about 2.5-5 minutes, the subject or user can remove the dental impression bite registration tool F and contoured impression material P from the subject's mouth. As shown in FIG. 38A (top impression) and FIG. 38B (bottom impression), the impression material P on the dental impression bite registration tool F has a detailed impression of the subject's top and bottom teeth and a detailed impression of the subject's gums above and below their teeth. The instructions 134 may then direct the subject or user to inspect the impression to make sure it is full, complete, and satisfactorily devoid of damaged portions.

Once all of the designated impression steps are completed, the user or subject can package the dental impression bite registration tool F and impression material P of FIGS. 38A and 38B in a return envelope or bag 136, put the bag or envelope and impression into a container 138, and ship or otherwise deliver the impression to a bite regulator fabricator or manufacturer. The manufacturer will then, based on the completed and detailed impression, make cement or other suitable molds that exactly match the user's impression. The impression automatically provides to the fabricator the precise three-dimensional jaw and bite registry for the particular subject. The manufacturer will then custom fabricate and fit a bite regulator, as described above, to fit the subject's upper teeth or lower teeth, depending on the model selected, and their natural bite registry. Once the bite regulator is fabricated, it can be return shipped or otherwise delivered to the subject as a completed product. The manufacturer can retain impressions so that the subject can order additional bite regulator products, if and when necessary.

In order to obtain the best possible impressions according to the foregoing methods, the subject and/or user can try and be careful in several of the steps. For one, the subject should try and ensure coverage of all of the front teeth and back molars with impression material P. The user and/or subject should also be careful not to twist, turn or move the dental impression bite registration tool F and impression material P during the process. This is to avoid blurring the impressions. The subject should also try and cover all the inside or lingual soft tissue, both the upper and lower gums, using their tongue, but can also avoid covering the entire palette. The subject can also try and cover all the outside or labial soft tissue, both the upper and lower gums so that the impression fully covers gum line to gum line. This can be important to ensure an accurate and complete impression and thus an accurate and complete reverse mold made from the impression.

As noted, the self-impression process may be performed entirely by the subject to be fitted or at least in part by another user assisting the subject with the process. The self-impression process described herein can also include more or fewer steps than the example described. The entire kit 130 may be provided to the subject or user in one of the envelopes or bags 136 or one of the boxes or containers 138. Alternatively, the kit components can be provided to the subject or user in piecemeal fashion. One the complete impression is taken, the end result is a single dental impression bite registration tool F with impression material P set on the curved section 146. This single unit can be packaged in one small container but should be packaged in a sturdy package to avoid damage to the impression during transport to the manufacturer.

In other examples, the process can include placing impression material on both arcuate sides of the curved section 146 on the dental impression bite registration tool F and performing one complete impression all at once. Also, the kit can be provided with dental impression trays and tools as noted above, and the subject can take an upper impression, and/or a lower impression, and a bite registration to make their impression(s), as needed. In another example, the subject can use a second identical tool and additional impression material to make multiple impressions of their teeth, bite and gums as described. The user can then send all impressions to the fabricator. The fabricator can compare the impressions for any anomalies, use the best portions of the impressions and/or bite registration and can remove or avoid or work around such anomalies when creating the bite regulators. In another example, the subject can get digitally scanned and fitted using intra-oral digital capturing technology for the impressions of the teeth and the bite registration. In this case the impressions are sent electronically to the lab for digital milling and custom manufacturing.

The above-noted custom impression bite forks 160 and 170 are shown in FIGS. 30, 31A, and 31B. Each of the dental impression bite registration tools is configured to serve or enhance several functions. The two dental impression bite registration bite forks 160, 170 are different in the one important aspect, as described herein regarding the vertical alignment or misalignment. Otherwise, only the dental impression bite registration bite fork 160 (Class I normal, FIG. 30) is described in detail herein with the understanding that, unless noted otherwise, the description applies to both forks.

The dental impression bite registration bite fork 160 has a handle or stem 144 that defines a central axis of the fork. A curved intraoral plate, i.e., the curved section 146, has a radial outer edge 180 to which the handle 144 is attached. The handle 144 is centrally located on and bisects the arc of the plate 146 and extends perpendicularly from the plate edge 180. An upstanding wall 182 is positioned along a central portion of the radial inner edge 184 of the intraoral plate 146. The wall 182 has a curvature that matches that of the plate 146 and is vertically perpendicular relative to a plane of the plate in this example.

An upper tooth positioner 186 is provided on the top side of the plate 146 and the handle 144, and a lower tooth positioner 188 is provided on the bottom side of the plate and handle. Each tooth positioner 186, 188 has a forward stop 190, 192, respectively, that protrudes upward or downward from the handle 144. Each forward stop 190, 192 has a generally flat, front contact surface 194, 196, respectively, that faces rearward and that contacts the outside surfaces of the user's front teeth during use. Each tooth positioner 186, 188 also has a rearward stop 198, 200, respectively, that protrudes upward or downward from the handle 144 and/or the plate 146. Each rearward stop 198, 200 carries the earlier mentioned ramped surface R that angles downward into the respective notch 162, 164 and forms a rear contact surface that faces forward. The ramped contact surfaces R are spaced from the front contact surfaces 194, 196 of the forward stops 190, 192. The ramped surface portion helps to guide a user's teeth into the space or gap, i.e., the notches 162, 164, between the front and rear contact surfaces. The subject's teeth will seat in these gaps during use to maintain the jaw position of the user while taking an impression. The bite forks can be manufactured with or without forward stops 190, 192, or with just a top forward stop 190, or just a bottom forward stop 192. A top forward stop 190 can be conducive for a better quality impression of the front lower teeth when manufacturing a lower fitting bite regulator. A bottom forward stop 192 can be more effective for a better quality impression of the front top teeth when manufacturing an upper hybrid bite regulator. If the person doing the fitting has crowned teeth or orthodontics on either the top, or bottom, or both, a single front stop 190, 192 or no front stop bite fork will allow them to do a better quality impression and bite registration. In all three cases, the reward stops 198, 200 will still effectively symmetrically align the jaw for a proper symmetrical bite position.

The tooth positioners 186, 188 on the Class I dental impression bite registration bite fork 160 are vertically aligned, as noted above. The tooth positioners 186, 188 on the Class II/III bite fork (FIGS. 42a, 42b) are offset to accommodate a larger degree of malocclusion, also as noted above. In this example, each of the rearward stops 198, 200 extends all the way back to and converges with a front side of the wall 182. The rearward stops 198, 200 can thus buttress the wall 182 and can add structural integrity and stiffness to the bite fork 160. The Class I dental impression bite registration bite fork has a marking 202 on one side of the handle 144 to identify the type of fork. The Class II/III dental impression bite registration bite fork 170 can have a different marking 204, 206 on each side of the handle 144 to identify the fork and also which orientation pertains to which bite type. The intraoral plate 146 can have dimples or recesses 208 on each side. These can be through holes, if desired. These dimples or holes 208 can fill with the impression material P during use and then help to retain the impression material on the plate 146 once the impressions are taken.

The dental impression bite registration tools can be constructed from any suitable material and can be modified from the various examples disclosed and described herein. In one example, the rearward distance that the plate 146 extends can vary, as can the radius or the arc of the curvature of the plate. As noted above, the thickness of the handle 144 and/or plate or curved section 146 can also vary. In one example, different versions of the dental impression bite registration tools can be produced with different thicknesses to accommodate and produce a different vertical spacing for each fork. The height, thickness, and width of the wall and the tooth positioner elements can also vary. The wall can be provided for a user's tongue to contact while taking an impression and thus its dimensions can be varied.

In another example, a digital scanner can also be successfully used in this process. A digital scanner can take all the necessary measurements for the nine separate factors noted above, while the patient's jaw is properly aligned. These measurements can be used in conjunction with the impress process described above to make the fabricated bite regulator product more accurate or to verify details of the impression, jaw position, and bite registry. In other alternatives, the process of having the bite regulators fabricated can also vary. For example, if a digital scanner were used, it can be used to scan the upper and lower arches of the teeth. The subject can then use the dental impression bite registration tool to obtain the correct jaw position. The scanner can then be used to scan the labial side of the upper and lower arches of the teeth and gums. The scanner can electronically save the data in a file, which can be e-mailed to the designated lab or approved lab for fabrication.

No one has heretofore developed a single tool that effectively registers full custom impressions the upper arch, lower arch and bite registration. No one has heretofore developed a single, fully customized impression and bite registration tool that fits every size mouth, and that does not use any water or electricity in the fitting process. No one has heretofore developed or offered a self-impression system and fully customized bite regulator mouth piece that registers the top teeth, bottom teeth, vertical spacing on the left, right and middle occlusal with kits or steps. The self-impression or professional fitting process can also utilize the aforementioned digital process or a one-step impression process instead of the two-step process described in detail herein.

Pro (Dentist—impression+bite fork)

SIS (Patient—impression+bite fork)

Dentist Fitting Process: 2 steps

PX3 dental impression bite registration bite fork to register the bite, and full upper and full lower arch impressions.

SIS Fitting process: 2 steps, 1 tool

PX3 dental impression bite registration bite fork to capture upper and lower arch impressions, and register the bite

In one example, the bite regulator models can have the following dimensional characteristics. It should be noted that the invention is not to be limited to the following examples.

Lower and Lower Hybrid Bite Regulators

Buccal extension—0.5mm to 4.0 mm apical from CEJ

2.0 mm to 6.0 mm thick

Flat, no contouring

Lingual extension—1 mm apical of CEJ

0.5 mm-2.5 mm thick

Embrasure contouring begins 3 mm apically from occlusal table

Feather edge lingual termination

Guard terminates at the first molar.

If there is no first molar, a first molar can be created in the guard

Round off distal lingual of last tooth covered by guard

Open/Flatten off buccal aspect of cuspid index

Occlusal index

0.5 mm 1.0 mm on lingual cusps

1 mm on buccal cusps

0.5 mm on lingual and buccal cusps of last tooth indexed

Labial connector

Polished intaglio, so there is little to no contact to hard and soft tissue

4 mm width from CEJ to incisal edge

Contoured when needed at labial frenum

Cuspid coverage extends no more than half of the tooth

Lingual cuspid concavity

No indexing past cuspids

Tongue Shelf

small concavity created on lingual

concavity extends throughout whole lingual surface posterior to anterior

concavity begins at occlusal table and extends only to beginning of embrasure line

concavity size is determined on the amount of material built on occlusal table. Some guards may have longer concavities due to space from occlusal table to embrasure line.

Lingual contouring

Hybrid Upper Bite Regulator

Buccal extension—0.5mm to 4.0 mm apical from CEJ

2.0 mm-5.0 mm thick

Flat, no contouring

Palatal extension—1 mm apical of CEJ

1 mm thick

2-3 mm from incisal edge to cingulum of anterior teeth (cuspid to cuspid)

Embrasure contouring begins 3 mm apically from occlusal table

Feather edge palatal termination

Guard terminates at the mesial half of the first molar

If there is no first molar a first molar can be created in the guard

Round off distal palatal of last tooth covered by guard

Open/Flatten off buccal aspect of cuspid index

Occlusal index

0.5 mm on lingual cusps

1 mm on buccal cusps

0.5 mm on lingual and buccal cusps of last tooth indexed

Cuspid palatal coverage extends no more than half the tooth

No indexing past cuspids

Lingual contouring

The disclosed fitting process can take you less than 15 minutes. The entire custom manufacturing and shipping processes can take up to 3 weeks depending on where the person resides. The disclosed custom fitting process of the bite regulators is also completely unique.

Bite regulators and features and self-impression processes, steps, systems, methods, components, and kits are disclosed herein and numerous performance and design aspects are disclosure for same. Various combinations of these features, processes, systems, methods, components, and kits can be provided on a given bite regulator or kit or performed for a given process. Any one of these disclosed features and processes, steps, systems, methods, components, and kits may be provided either separate from or in combination with any one or more of the other of same, where possible, even though that particular combination or arrangement is not specifically disclosed or described herein.

Although certain bite regulators and features and self-impression processes, steps, systems, methods, components, and kits have been described herein in accordance with the teachings of the present disclosure, the scope of coverage of this patent is not limited thereto. On the contrary, this patent covers all embodiments of the teachings of the disclosure that fairly fall within the scope of permissible equivalents.

What is claimed is:

1. A method of custom fitting a mouth piece, the method comprising:
providing a self-impression kit including at least one dental impression bite registration tool, impression material, and instructions, the instructions directing the following steps:
determining a bite position of a subject utilizing the bite registration tool, applying impression material to an intraoral portion of the bite registration tool,
placing the bite registration tool and the impression material in the subject's mouth,
forming an impression of the subject's teeth and gums in the impression material by the subject biting on the intraoral portion of the dental impression bite registration tool in the previously determined natural bite position, and
delivering the dental impression bite registration tool and formed impression material to a manufacturer to have a bite regulator fabricated using the formed impression.

2. The method according to claim 1, wherein the step of providing includes providing a plurality of the dental impression bite registration tools.

3. The method according to claim 2, wherein at least two tools of the plurality of dental impression bite registration tools are configured differently from one another, each being configured to accommodate a different natural bite position type.

4. The method according to claim 3, wherein the step of providing includes providing multiple packages of the impression material.

5. The method according to claim 1, wherein the step of determining includes instructing that the natural fore-aft position of the subject's upper front teeth be determined relative to the subject's lower front teeth in the natural bite position.

6. The method according to claim 1, wherein the step of determining includes instructing that the natural vertical spacing of the subject's upper front teeth be determined relative to the subject's lower front teeth in the natural bite position.

7. The method according to claim 1, wherein the step of determining includes instructing that the symmetrical or natural side-to-side position of the subject's upper front teeth be determined relative to the subject's lower front teeth in the natural bite position.

8. The method according to claim 1, wherein the step of determining includes instructing that:
the natural fore-aft position of the subject's upper front teeth be determined relative to the subject's lower front teeth in the natural bite position;
the natural vertical spacing of the subject's upper front teeth be determined relative to the subject's lower front teeth in the natural bite position; and
the natural side-to-side position of the subject's upper front teeth be determined relative to the subject's lower front teeth in the natural bite position.

9. The method according to claim 1, wherein the step of providing includes providing one or more bite forks as the bite registration tools, the bite forks defining upper and lower notches for receiving the respective upper and lower front teeth of the subject during the steps of determining and forming.

10. The method according to claim 1, wherein the instructions for the steps of applying, placing, and forming direct that they be performed for the teeth and gums on a first side of the subject's mouth and then be repeated for the teeth and gums on the second side of the subject's mouth, the formed impression material from the first side remaining on the dental impression bite registration tool when the steps of applying, placing, and forming are performed for the second side.

11. The method according to claim 1, wherein the steps of determining, applying, placing, and forming further including instructing that these steps be performed by the subject, by a user assisting the subject, or both.

12. A method of custom fabricating a mouth piece, the method comprising:
providing a self-impression kit including at least one dental impression bite registration tool, impression material, and instructions, the instructions directing a subject to:
determine the subject's natural bite position utilizing the dental impression bite registration tool,
apply impression material to an intraoral portion of the dental impression bite registration tool,
place the dental impression bite registration tool and the impression material in their mouth,
form an impression of their teeth and gums in the impression material by biting on the intraoral portion of the dental impression bite registration tool in the previously determined natural bite position, and
deliver the dental impression bite registration tool and formed impression material to a manufacturer to have a bite regulator fabricated using the formed impression.

13. The method according to claim 12, wherein the step of providing includes providing at least two of the dental impression bite registration tools, each dental impression bite registration tool configured differently from one another and being configured to accommodate a different natural bite position type.

14. The method according to claim 12, wherein the step of determining includes instructing the subject to determine the natural fore-aft position of their upper front teeth relative to their lower front teeth in the natural bite position.

15. The method according to claim 12, wherein the step of determining includes instructing the subject to determine the natural vertical spacing of their upper front teeth relative to their lower front teeth in the natural bite position.

16. The method according to claim 12, wherein the step of determining includes instructing the subject to determine the natural side-to-side position of their upper front teeth relative to their lower front teeth in the natural bite position.

17. The method according to claim 12, wherein the step of determining includes instructing the subject to determine:
the natural fore-aft position of their upper front teeth relative to their lower front teeth in the natural bite position;
the natural vertical spacing of their upper front teeth relative to their lower front teeth in the natural bite position; and
the natural side-to-side position of their upper front teeth relative to their lower front teeth in the natural bite position.

18. The method according to claim 1, wherein the instructions for the steps of applying, placing, and forming direct the subject to perform these steps for their teeth and gums on a first side of their mouth, and then subsequently repeat the steps for their teeth and gums on the second side of their mouth while leaving the formed impression material from the first side on the bite registration tool when the steps of applying, placing, and forming are performed for the second side.

19. The method according to either of claims 1 and 12, wherein the step of delivering results in the manufacturer producing a bite regulator comprising:
a front band with left and right ends; and
left and right molar sections extending rearward respectively from the left and right ends of the front band,
wherein the left and right molar sections each have an interocclusal region with a contoured top surface and a contoured bottom surface, and wherein the contoured top and bottom surfaces are each configured to match a specific contour of the wearer's top and bottom teeth, respectively, and are aligned relative to one another to correctly position the wearer's jaw.

20. The method of claim 19, wherein the step of delivering results in the manufacturer producing the bite regulator wherein the front band is a labial band configured to contact only an outer facing side of the subject's front teeth.
